(19) United States
(12) Patent Application Publication
(10) Pub. No.: US 2008/0257638 A1
(43) Pub. Date: Oct. 23, 2008

(54) Production method of an acoustic diaphragm, acoustic diaphragm, and a speaker

(76) Inventors: Yoshiaki Suzuki, Kanagawa-ken (JP); Yoshiaki Tanaka, Kanagawa-ken (JP); Shinichi Hirose, Kanagawa-ken (JP)

Correspondence Address: NATH & ASSOCIATES, 112 South West Street, Alexandria, VA, 22314, US

(21) Appl. No.: 12/078,530

(22) Filed: Apr. 1, 2008

Related U.S. Application Data
(63) Continuation-in-part of application No. 11/698,167, filed on Jan. 26, 2007.

(30) Foreign Application Priority Data
Jan. 27, 2006 (JP) P2006-019101
Jan. 27, 2006 (JP) P2006-019105
Oct. 17, 2006 (JP) P2006-282464
Oct. 17, 2006 (JP) P2006-282466
Apr. 2, 2007 (JP) P2007-096873
Aug. 16, 2007 (JP) P2007-212222
Jan. 31, 2008 (JP) P2008-021907

(51) Int. Cl. H04R 7/02; B05D 3/02

(52) U.S. Cl. 181/167; 427/227

(57) ABSTRACT

A method of producing an acoustic diaphragm includes forming a workpiece having a shape of the acoustic diaphragm by using a natural material which can be carbonized by burning; forming a first film including phenol resin on a surface and an interior of the workpiece; heating the workpiece to bring the phenol resin into a high polymer state; burning the workpiece in a substantially anoxic atmosphere to carbonize the workpiece and the first film; and forming a second film including gelatin on at least one of a surface and an interior of carbonized workpiece.

### CROSS REFERENCE TO RELATED APPLICATIONS

This application is a continuation-in-part of application Ser. No. 11/698,167, filed on Jan. 26, 2007. This application is also based upon and claims the benefit of priority from the prior Japanese Patent Applications No. P2006-019101, filed on Jan. 27, 2006, No. P2006-019105, filed on Jan. 27, 2007, No. P2006-282464, filed on Oct. 17, 2006, No. P2006-282466, filed on Oct. 17, 2006, No. P2007-096873, filed on Apr. 2, 2007, No. P2007-212222, filed on Aug. 16, 2007, and No. P2008-021907, filed Jan. 31, 2008; the entire contents of which are incorporated herein by reference.

### BACKGROUND OF THE INVENTION

1. Field of the Invention

The present invention relates to a method of producing an acoustic diaphragm, an acoustic diaphragm, and a speaker using the acoustic diaphragm.

2. Description of the Related Art

As an acoustic diaphragm for a speaker that emits a clear sound with minimum distortion, a diaphragm having a high carbonization ratio has been attracted attention. A diaphragm with a high carbonization ration is obtained by burning a natural diaphragm material that includes various types of organic matter at a high temperature to carbonize the organic matter. A large number of fine holes are generates in the diaphragm as it is carbonized. As a result, air leakage occurs when such a diaphragm is used as a speaker. The air leakage causes sound deterioration, which is a problem to be solved for an acoustic diaphragm used in a speaker.

Air leakage that occurs in an acoustic diaphragm in a speaker will be described. An acoustic diaphragm in a speaker vibrates in response to electronic signals to push and pull air around the diaphragm. As a result, compression wave (longitudinal wave which vibrates in the same direction as the wave passing through) of air according to the electronic signals is generated and a person senses the vibrations as sounds. In a series of operations, when there is a through hole penetrating from the front surface to the rear surface of the acoustic diaphragm, air around (particularly in front of) the diaphragm will not be pushed or pulled by vibrations of the acoustic diaphragm so that a compression air wave is not generated. Thus, the amount of compression waves for an entire speaker is decreased and the amount that a person hears as sound is decreased.

Since a new airflow is generated in the through hole that penetrates from the front surface to the rear surface of the acoustic diaphragm according to the vibrations of the acoustic diaphragm, other compression air wave, which is different from the original compression air wave, is generated. The other compression air wave creates noise and the noise causes sound deterioration.

Examples of conventional carbonized acoustic diaphragms will be described. Japanese Unexamined Patent Application Laid-Open (Koukai) No. 60 (1985)-54596 (hereinafter called “JP 60-54596”) discloses that when a thin metal layer made from a material such as boron and beryllium is provided on a carbonized surface, a more rigid diaphragm is obtained. However, JP 60-54596 does not disclose a feature for air leakage. Also, it is not clear whether or not the thin metal layer can prevent the air leakage. JP 60-54596 discloses that manageability of the diaphragm is improved when a material such as acrylic lacquer is applied on the surface of the thin metal layer. However, it is not still clear that the above thin metal layer can prevent the air leakage.

Similar to JP 60-54596, Japanese Examined Patent Publication (Koukoku) No. 57 (1982)-31356 (hereinafter called “JP 57-31356”) discloses that when a thin metal layer made from a material such as boron and beryllium is provided on a burned and carbonized surface, a diaphragm with increased rigidity is obtained. However, JP 57-31356 does not disclose the feature for air leakage and it is not clear whether or not the thin metal layer prevents the air leakage.

Japanese Unexamined Patent Application Laid-Open No. 2002-34096 (hereinafter called “JP 2002-34096”) discloses that a liquid mixture of dye and pigment is impregnated into a burned porous surface material to produce a surface color. However, JP 2002-34096 does not disclose a feature for preventing air leakage and it is not clear whether or not the impregnated burned porous surface prevents the air leakage.

As described above, JP 60-54596, JP 57-31356 and JP 2002-34096 are inventions to obtain an acoustic diaphragm by a burning process. However, materials to be burned and materials to be applied are different. Any effective feature for an air leakage is not taken or is not sufficient.

### SUMMARY OF THE INVENTION

An object of the present invention is to cover the fine holes of a diaphragm having a high carbonization ratio which are generated in a process of burning a natural diaphragm material containing various types of organic matter and to prevent sound deterioration due to air leakage when the diaphragm is used in a speaker.

Another object of the present invention is to realize an improvement in the strength of the acoustic diaphragm having a high carbonization ratio and to improve the manageability in an assembling process of a speaker using the diaphragm and to improve the strength reliability of the speaker.

Another object of the present invention is to increase internal losses of an acoustic diaphragm and to absorb strain components of the diaphragm used in a speaker, in order to improve frequency characteristic.

According to an aspect of the present invention, firstly, a workpiece is formed in a shape of the acoustic diaphragm. The diaphragm is formed from a natural material of organic matter that is carbonized by burning. After, a solution containing phenol resin is applied to the obtained workpiece. The workpiece is heated to a predetermined temperature to bring the phenol resin into a high polymer state. Then, the workpiece is burned under a substantially anoxic atmosphere to carbonize the organic matter. Although these foregoing processes are substantially the same as conventional techniques, according to the present invention, the burned workpiece is applied or impregnated with a coating material including a solution containing phenol resin.

In the present invention, the “natural material” represents materials found in nature such as wood, paper pulp, natural fiber (including botanical fiber and animal fiber), fabric or string of the natural fiber, leather, or combined material of the above and processed materials made of materials found in nature. Natural materials include carbon and have an advantage of having fine shapes. In the following embodiments, cotton fiber and softwood fiber are used as natural materials; however, hemp fiber and broadleaf fiber or the like may be also employed.

As a coating material including a solution of phenol resin (hereinafter referred to as “phenol Resin coating material”), a solution prepared by dissolving phenol resin into a solvent containing water and alcohols having a low boiling temperature (lower than about 80° C.) such as methanol and ethyl acetate is preferable for increasing the productivity and the yield. Such a phenol resin coating material has an advantage that its quality is reliable compared to natural materials so that a certain level of quality can be easily obtained.

Portions of the workpiece where the phenol resin coating material is applied is not limited as long as it is effective to prevent air leakage; however, since an edge of the workpiece has a large number of openings of vessels in wood, it is particularly effective to apply the phenol resin coating material to the edge of the workpiece. Further, when the phenol resin coating material is applied only to the edge, the weight of the diaphragm can be decreased so that it provides excellent acoustic properties.

According to another aspect of the present invention, a workpiece is formed in the shape of an acoustic diaphragm using a natural material including organic matter that is carbonized by burning. After a solution containing phenol resin is applied to the obtained workpiece, the workpiece is heated to a predetermined temperature to bring the phenol resin into a high polymer state. Then, the workpiece is burned under a substantially anoxic atmosphere to carbonize the organic matter. Although these foregoing processes are substantially the same as conventional techniques, according to the present invention, the burned workpiece has applied thereon or impregnated with a lacquer (Japanese lacquer) coating material. The workpiece is hardened by at least one method of keeping the obtained workpiece under a predetermined degree of humidity or heating the obtained workpiece at a predetermined temperature.

Here, as another means, there may be a method for applying an organic water-soluble resin coating material containing resin as a major ingredients (such as polyvinyl alcohol and nitrocellulose) dissolved in a solvent having a low boiling temperature (lower than about 80° C.) such as methanol and ethyl acetate. However, when a solvent having a low boiling temperature is employed, an organic solvent in the fine holes of the carbonized diaphragm evaporates rapidly. In this event, evaporation pressure is created. The evaporation pressure causes fractures in the carbonized diaphragm.

On the other hand, the lacquer coating material contains lacquer oil and moisture but does not contain the organic solvent having a low boiling temperature. Accordingly, when the lacquer coating material is employed, such a rapid evaporation pressure is not created. Further, since a reaction of hardening the lacquer coating material progresses slowly, moisture in the lacquer coating material will evaporate progressively and be completely removed. Therefore, applying a lacquer coating material to a diaphragm having a high carbonization ratio prevents fractures and covers the fine through holes in the diaphragm.

Further, a hardened membrane is formed by hardening lacquer ingredients, which are a state of oil in the lacquer coating material, due to a reaction catalyzed by an enzyme contained in the moisture in the lacquer coating material. Here, the same effect can be obtained by using an oil-in-water type coating material by completely mixing water and oil, in which a laccase is provided in water as enzyme and an urushiol is used as an oil.

When a lacquer coating material containing urushiol as a major ingredient is used, a hardened membrane can be also obtained not only by enzymic reaction but also by high-temperature processing at over 120° C. Thus, after a carbonized diaphragm is applied with or impregnated with the lacquer coating material, the object of the present invention can be achieved sufficiently by heating the diaphragm at over 120° C., preferably around 150° C.

The lacquer coating material of the oil-in-water type may be diluted by water or a hydrocarbon solvent (Hydrocarbon solvent represents aliphatic hydrocarbon, aromatic hydrocarbon, hydrogenated hydrocarbon, terpene hydrocarbon, and halogenated hydrocarbon and, here, examples of kerosene and turpentine oil will be described.). In this case, more moisture is used in order to slow the hardening and more solvent is used in order to decrease the degree of viscosity and increase permeability. A lacquer coating material having an appropriate component mixture ratio can be used, depending on the condition of the size, or distribution of the fine holes of the carbonized diaphragm. Applying the lacquer coating material in this way is effective not only for preventing air leakage but also for adjusting strength and internal losses of the diaphragm.

Since the lacquer coating material is made of natural materials, it is more preferable than synthesized materials made by coal oil in view of environmental protection. On the other hand, since lacquer is a natural material, there are some disadvantages such that wide variations in quality are found and that a person who treats the material may have a skin irritation. However, once it is made into a product, it is safe for people and overcomes environmental issues.

Portions of the workpiece where the lacquer coating material is applied is not limited as long as it is effective to prevent air leakage; however, since edge portions of the workpiece has a large number of openings of vessels in wood, it is particularly effective to apply the lacquer coating material to the edge portions of the workpiece. Further, when the phenol resin coating material is applied only to the edge portions, the weight of the diaphragm can be reduced so that it is effective for enhancing acoustic properties.

According to the acoustic diaphragm produced by the production method of the present invention, fine holes in the diaphragm are covered so that air leakage does not occur when a speaker using the acoustic diaphragm is driven. As a result, sound deterioration is prevented.

Further, the fine holes in the diaphragm are covered so that the strength of the diagram is increased. As a result, the acoustic diaphragm will not easily damaged when a speaker is assembled with the diaphragm and its production manageability is increased.

Further, since internal losses of the acoustic diaphragm are increased to absorb strain components when the diaphragm is used in a speaker, frequency characteristic will be improved.

### BRIEF DESCRIPTION OF THE DRAWINGS

In the accompanying drawings:

FIG. 1 is a flowchart of a production method according to a first embodiment of the present invention;

FIGS. 2A to 2G are explanatory diagrams of the production method according to the first embodiment of the present invention;

FIG. 3 is a graph showing a characteristic feature of an acoustic diaphragm according to the first embodiment of the present invention;

FIG. 4 is a flowchart of a production method according to a second embodiment of the present invention;

FIGS. 5A to 5G are explanatory diagrams of the production method according to the second embodiment of the present invention;

FIG. 6 is a flowchart of a production method according to a third embodiment of the present invention;

FIGS. 7A to 7H are explanatory diagrams of the production method according to the third embodiment of the present invention;

FIG. 8 is a graph showing a characteristic feature of an acoustic diaphragm according to the third embodiment of the present invention;

FIG. 9 is a flowchart of a production method according to a fourth embodiment of the present invention;

FIGS. 10A to 10G are explanatory diagrams of the production method according to the fourth embodiment of the present invention;

FIG. 11 is a flowchart of a production method according to a fifth embodiment of the present invention;

FIGS. 12A to 12G are explanatory diagrams of the production method according to the fifth embodiment of the present invention;

FIG. 13 is a speaker according to the fifth embodiment of the present invention;

FIG. 14 is a flowchart of a production method according to a sixth embodiment of the present invention;

FIGS. 15A to 15H are explanatory diagrams of the production method according to the sixth embodiment of the present invention;

FIG. 16 is a graph showing a characteristic feature of an acoustic diaphragm according to the sixth embodiment of the present invention;

FIG. 17A is a speaker according to the sixth embodiment of the present invention;

FIG. 17B is a partial expanded view illustrating an example of an acoustic diaphragm shown in FIG. 17A;

FIG. 18 is a flowchart of a production method according to a seventh embodiment of the present invention;

FIGS. 19A to 19I are explanatory diagrams of the production method according to the seventh embodiment of the present invention;

FIG. 20 is a graph showing a characteristic feature of an acoustic diaphragm according to the seventh embodiment of the present invention;

FIG. 21A is a speaker according to the seventh embodiment of the present invention;

FIG. 21B is a partial expanded view illustrating an example of an acoustic diaphragm shown in FIG. 21A;

FIG. 22 is a flowchart of a production method according to an eighth embodiment of the present invention;

FIGS. 23A to 23F are explanatory diagrams of the production method according to the eighth embodiment of the present invention;

FIG. 24A is a speaker according to the eighth embodiment of the present invention;

FIG. 24B is a partial expanded view illustrating an example of an acoustic diaphragm shown in FIG. 24A;

FIG. 25 is a flowchart of a production method according to a ninth embodiment of the present invention;

FIGS. 26A to 26H are explanatory diagrams of the production method according to the ninth embodiment of the present invention;

FIG. 27 is a graph showing a characteristic feature of an acoustic diaphragm according to the ninth embodiment of the present invention;

FIG. 28 is a flowchart of a production method according to a tenth embodiment of the present invention;

FIGS. 29A to 29H are explanatory diagrams of the production method according to the tenth embodiment of the present invention;

FIG. 30 is a graph showing a characteristic feature of an acoustic diaphragm according to the tenth embodiment of the present invention;

FIG. 31 is a flowchart of a production method according to an eleventh embodiment of the present invention;

FIGS. 32A to 32E are explanatory diagrams of the production method according to the eleventh embodiment of the present invention;

FIG. 33A is a speaker according to the eleventh embodiment of the present invention;

FIG. 33B is a partial expanded view illustrating an example of an acoustic diaphragm shown in FIG. 33A;

FIG. 34A is another speaker according to the eleventh embodiment of the present invention; and

FIG. 34B is another partial expanded view illustrating an example of an acoustic diaphragm shown in FIG. 33A.

### DESCRIPTION OF THE PREFERRED EMBODIMENTS

Various embodiments of the present invention will be described with reference to the accompanying drawings.

### First Embodiment

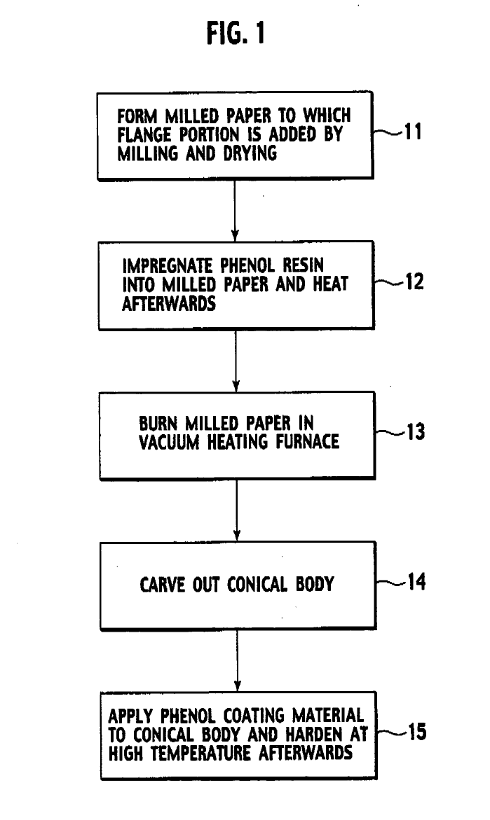

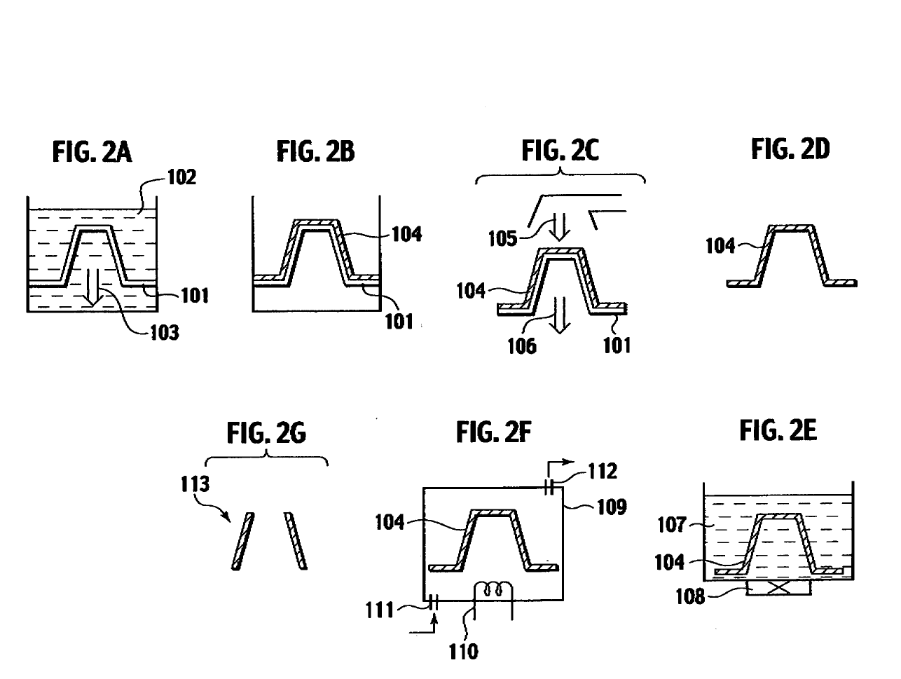

A first embodiment of the present invention will be described. FIGS. 1 and 2A to 2F are explanatory diagrams of a production method according to the first embodiment.

At a first step 11 in FIG. 1, as shown in FIG. 2A, a previously formed mesh 101 having a center portion has a conical shape (truncated shape) is prepared. (Since the workpiece contracts due to a burning operation, the mesh may be formed larger than the size of the workpiece after the burning operation. For example, when it is heated at 800° C., contraction of, for example, 25% in the longitudinal direction is taken into consideration, and the mesh is formed larger by this value.) The mesh 101 is put into a dispersion liquid 102 into which mixture fiber of 90 wt % of linter (cotton fiber) 10 wt %+NBKP [Needle Bleach Kraft Pulp] (softwood fiber is made into pulp by the kraft process and is further bleached) is dispersed, and the mixture fiber is milled into paper on the mesh 101. A reference number 103 in FIG. 2A represents a suction direction when paper is milled, and a reference number 104 in FIG. 2B represents milled paper. The mesh 101 can be made of metal such as brass; however, the material is not limited to metals and any strong and heat resistant material can be used.

To remove moisture from the milled paper 104 on the mesh 101, hot air 105 (e.g., in a range of 100° C. to 200° C., as an example, at 150° C.) is blown on the milled paper 104 and the mesh 101 is vacuum-sucked from below at the same time as shown in FIG. 2C. A reference number 106 in FIG. 2C represents the vacuum-suction airflow.

At a second step 12 in FIG. 1, the milled paper 104 is detached from the mesh 101 as shown in FIG. 2D, and is immediately immersed in an alcohol solution 107 of phenol resin (phenol resin containing ratio is about 15 wt %) and is impregnated with the alcohol solution 107 as shown in FIG. 2E. At that time, the entire alcohol solution 107 of phenol resin is subjected to ultrasonic oscillation for about five minutes by an ultrasonic oscillator 108 for example, so that the alcohol solution 107 is fully permeated into the milled paper 104. The milled paper 104 is taken out from the solution 107 and sufficiently dried, and the milled paper 104 is then heated for about ten minutes at about 180° C. so that the phenol resin, which is a short molecule, is brought into a high polymer state.

Next, at a third step 13 in FIG. 1, as shown in FIG. 2F, the milled paper 164 impregnated with phenol resin is placed in a vacuum heating furnace 109, and is heated from a room temperature to 800° C. by a heater 110 in a substantially anoxic atmosphere (for example, nitrogen gas atmosphere). After the milled paper 104 is held for 30 minutes at 800° C., it is gradually cooled to the room temperature and is taken out from the furnace. With this step, the organic matter included in the milled paper 104 is carbonized. Thus, a large number of fine holes are formed in the milled paper 104 so as to be porous. A reference number 111 represents an introduction port for nitrogen gas or the like, and a reference number 112 represents a discharge port for nitrogen gas or the like.

Next, at a fourth step 14 in FIG. 1, as shown in FIG. 2G, a porous carbide conical body 113 is carved out by cutting. When paper is milled, if a small step portion is formed at a boundary between the conical shaped portion and the flat portion of the milled paper 104, it can be cut by a router or a laser cutter, or the like using the small step portion as a guideline, so it is possible to obtain a precise shape.

Next, at a fifth step 15 in FIG. 1, a phenol resin coating material (containing methanol of about 10 wt % and moisture of about 40 wt %) is applied to edge portions and the entire surface of the porous carbide 113. After the porous carbide 113 is dried, it is heated in an atmosphere of substantially 180° C. so as to be almost entirely hardened. The almost entirely hardened workpiece is effective to prevent air leakage when the workpiece is used as an acoustic diaphragm.

Since the phenol resin coating material is water-soluble, it permeates into the holes of the porous carbide when the porous carbide is coated by or impregnated with the phenol resin coating material. Thus, the probability of fracture of the carbonized diaphragm is remarkably reduced. Further, since the phenol resin coating material permeates into the holes of the porous carbide and forms a phenol resin film (hardened material of the phenol resin coating material) inside and around the carbonized material, the strength of the carbonized material as an acoustic diaphragm is increased. At the same time, since the phenol resin film increases internal losses to absorb strain components when the diaphragm is installed as a speaker, the frequency characteristic will be improved.

Further, since phenol resin is a material that withstands long use under a high-temperature environment over 100° C., an acoustic diaphragm according to the present invention can be applied to a speaker which can withstand long use under a high-humidity environment. Further, since phenol resin has ultraviolet resistance, the acoustic diaphragm according to the present invention can be applied to a PA (public address system) placed in an outdoor severe environment (for example, at sports stadiums, outdoor theaters, stations, bus stops, and the like). There is little quality variation in phenol resin compared to natural materials so that phenol resin is industrially easy to handle.

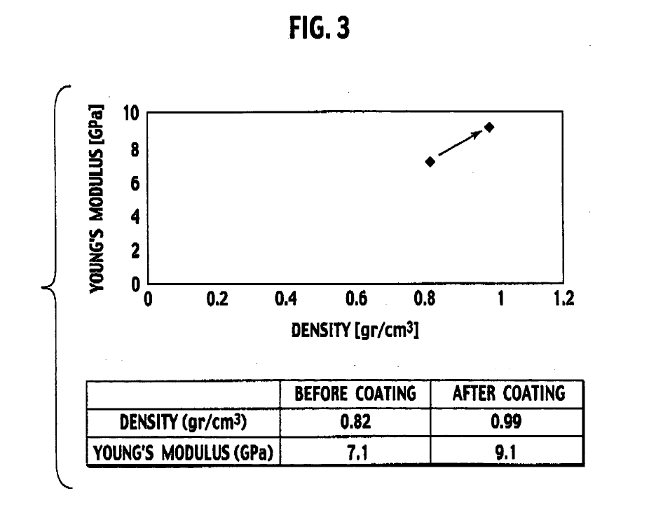

For example, when a workpiece is almost entirely hardened by heating for 30 minutes at 180° C., increased weight of the workpiece is about 20 wt % (compared to the porous carbide 113 before being coated by the phenol resin coating material). However, the weight is within a range required for an acoustic diaphragm and the Young's modulus increases about 28% from 7.1 GPa of a workpiece before coating to 9.1 GPa of a workpiece after coating (compared to the porous carbide 113 before being coated by the phenol resin coating material). As a result, a sufficient strength is implemented to the diaphragm so as not to be damaged in an assemble process of a speaker using the acoustic diaphragm. A relationship between the Young's modulus and the density before and after coating is shown in FIG. 3.

While it is preferable to use nitrogen gas as the anoxic atmosphere because it is inexpensive and is readily available, argon, high vacuum atmosphere, and the like can be used other than the nitrogen gas.

Further, in the present embodiment, material containing 40 wt % of moisture as a phenol resin coating material is used. However, the moisture amount is not limited to the above-described value and a material containing about 5 wt % to 70 wt % of moisture may also be used. When a carbonized diaphragm is coated with a material containing less than 4 wt % of moisture, the probability of fracture occurring in a carbonized diaphragm is extremely high. When the carbonized diaphragm is coated with a material containing more than 75 wt % of moisture, the phenol resin coating material becomes clouded. In the present embodiment, alcohol concentration is preferably in a range of from 5 wt % to 90 wt %, and the phenol resin concentration is preferably more than 5 wt %. The optimum value of those densities should be arbitrarily set according to the weight of a required acoustic diaphragm.

### Second Embodiment

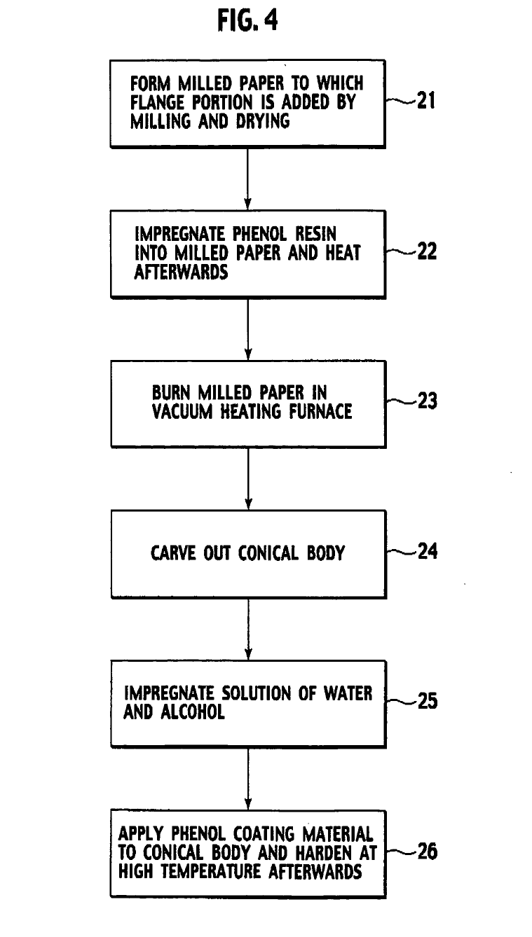

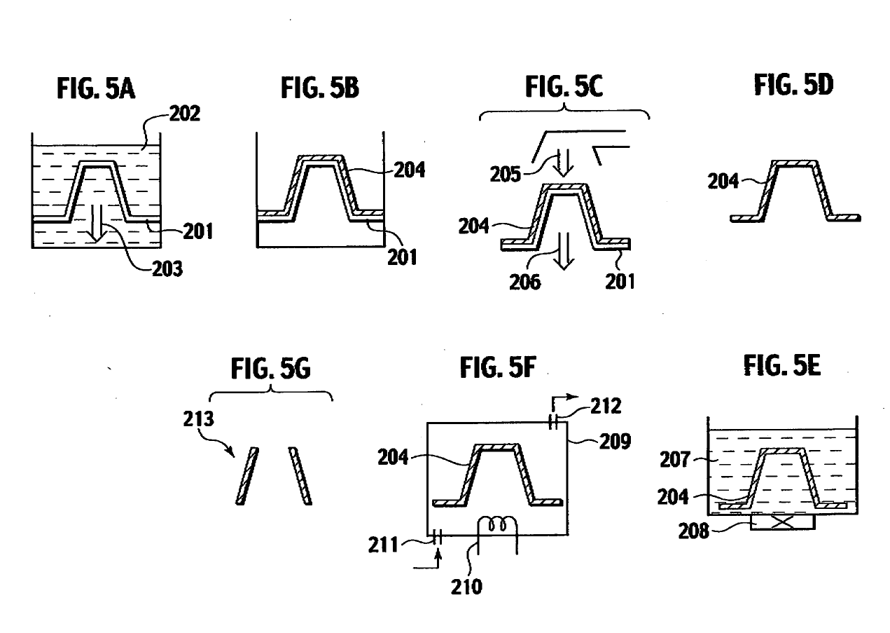

FIGS. 4 and 5A to 5G are explanatory diagrams of a production method according to the second embodiment.

At a first step 21 in FIG. 4, as shown in FIG. 5A, a previously formed mesh 201 having a center portion has a conical shape (truncated shape) is prepared. (Since the workpiece contracts due to a burning operation, the mesh may be formed larger than the size of the workpiece after the burning operation. For example, when it is heated at 800° C., contraction of, for example, 25% in the longitudinal direction is taken into consideration, and the mesh is formed larger by this value). The mesh 201 is put into a dispersion liquid 202 into which mixture fiber of 90 wt % of linter (cotton fiber) 10 wt %+NBKP [Needle Bleach Kraft Pulp] (softwood fiber is made into pulp by a kraft process and is further bleached) is dispersed, and the mixture fiber is milled into paper on the mesh 201.

A reference number 203 represents a suction direction when paper is milled, and a reference number 204 in FIG. 5B represents milled paper. The mesh 201 can be made of metal such as brass, but the material is not limited to this, and any strong and heat resistant material can be used.

To remove moisture from the milled paper 204 on the mesh 201, hot air 205 (e.g., in a range of 100° C. to 200° C., as an example, at 150° C.) is blown on the milled paper 204 and the mesh 201 is vacuum-sucked from below at the same time as shown in FIG. 5C. A reference number 206 represents the vacuum-suction airflow.

At a second step 22 in FIG. 4, the milled paper 204 is detached from the mesh 201 as shown in FIG. 5D, and is immediately immersed in alcohol solution 207 of phenol resin (phenol resin containing ratio is about 15 wt %) as shown in FIG. 5E, and the alcohol solution 207 is impregnated into the paper. At that time, the entire alcohol solution 207 of phenol resin is subjected to ultrasonic oscillation for about five minutes by an ultrasonic oscillator 208 so that the alcohol solution 207 fully impregnates into the milled paper 204.

The milled paper 204 is taken out from the solution 207 and sufficiently dried, and the milled paper 204 is then heated for about ten minutes at about 180° C. so that the phenol resin, which is a short molecule, is brought into a high polymer state.

Next, at a third step 23 in FIG. 4, as shown in FIG. 5F, the milled paper 204 in which phenol resin is impregnated is placed in a vacuum heating furnace 209, and is heated from a room temperature to 800° C. by a heater 210 in a substantially anoxic atmosphere (for example, nitrogen gas atmosphere). After the milled paper 204 is held for 30 minutes at 800° C., it is gradually cooled to the room temperature and is taken out from the furnace. With this step, the organic matter included in the milled paper 204 is carbonized. With this step, a large number of fine holes are formed in the milled paper 204 so as to form a porous carbide. A reference number 211 represents an introduction port for nitrogen gas or the like, and a reference number 212 represents a discharge port for nitrogen gas or the like.

Next, at a fourth step 24 in FIG. 4, as shown in FIG. 5G, a porous carbide conical body 213 is carved out by cutting. When paper is milled, if a small step portion is formed at a boundary between the conical shaped portion and the flat portion of the milled paper 204, it can be cut by a router, a laser cutter, or the like using the small step portion as a guideline, so it is possible to obtain a precise shape.

Next, at a fifth step 25 in FIG. 4, edge portions and the entire surface of the porous carbide 213 are impregnated with a mixed liquid containing 50 wt % of methanol and 50 wt % of moisture.

At a sixth step 26 in FIG. 4, a phenol resin coating material (containing methanol of about 10 wt % and moisture of about 40 wt %) is applied to the edge and the entire surface of the porous carbide 213. After the porous carbide 213 is dried, it is heated for 30 minutes in an atmosphere at substantially 100° C., and further heated for 30 minutes in an atmosphere at substantially 1800° C. so as to be almost entirely hardened. The almost entirely hardened workpiece is effective to fill the holes of the porous carbide 213 and can prevent air leakage when the workpiece is used as an acoustic diaphragm.

Since the phenol resin coating material is water-soluble, it permeates into the holes in the porous carbide when the porous carbide is coated by or impregnated with the phenol resin coating material. As a result, the occurrence of fractures of the carbonized diaphragm is remarkably reduced. Further, since a great deal of the phenol resin coating material permeates into the holes located near the surface of the porous carbide and forms a phenol resin film (hardened material) near the surface of the porous carbide, the rest of the phenol resin does not enter the holes located on the inner side of the porous carbide. Accordingly, a lightweight and strong carbonized material, for use as an acoustic diaphragm, is realized. Further, since the phenol resin film improves internal losses of the porous carbide, distortion of the carbonized material as an acoustic diaphragm is prevented. At the same time, since generated strain components are absorbed, frequency characteristic can be improved.

When the porous carbide 213 is previously impregnated with the mixed liquid of methanol and moisture, a phenol resin layer is provided mainly on the outer portion of the porous carbide 213 after the phenol resin is hardened. This is effective for filling the holes of the porous carbide 213, reduction of weight of the acoustic diaphragm, and acquiring higher internal losses.

While it is preferable to use nitrogen gas as the anoxic atmosphere because it is inexpensive and is readily available, argon, high vacuum atmosphere, and the like can be used instead of the nitrogen gas.

In the present embodiment, mixed liquid of 50 wt % of methanol and 50 wt % of moisture is used, however, the mixed liquid should not be limited to such values and the percentage can be arbitrarily set according to characteristics of a required diaphragm. For example, more phenol resin films are applied to the outer portion of the porous carbide 213 when the mixed liquid is prepared with 70 wt % of methanol and 30 wt % of moisture, compared to the case of using a mixed liquid with 50 wt % of methanol and 50 wt % of moisture. Also, the mixed liquid should not be limited to methanol and any alcohols having a low boiling temperature such as ethanol can be used. Further, the present embodiment should not be limited to a phenol resin coating material with 40 wt % of moisture and 10 wt % of alcohol and the optical density value should be arbitrarily set according to the weight or properties of a required acoustic diaphragm. For example, in order to provide a diaphragm requiring a large mechanical strength, the percentage of phenol resin is increased with 10 wt % of moisture and 10 wt % of alcohol so as to increase the amount of phenol resin attached thereto. As a result, mechanical strength of the diaphragm is improved.

### Third Embodiment

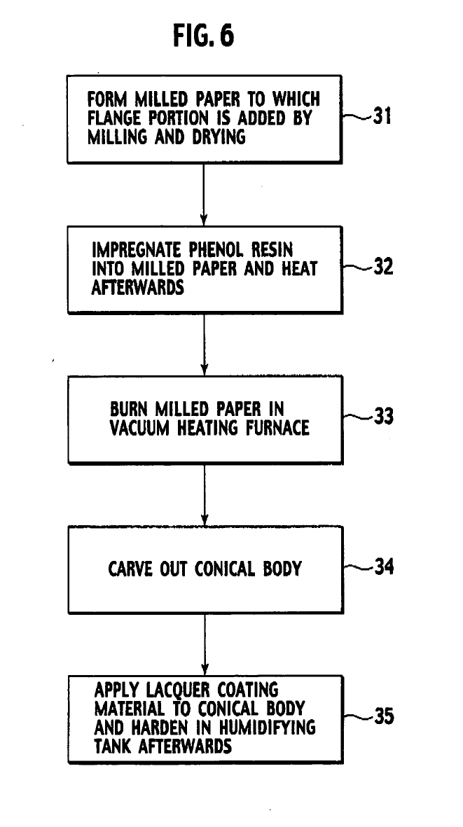

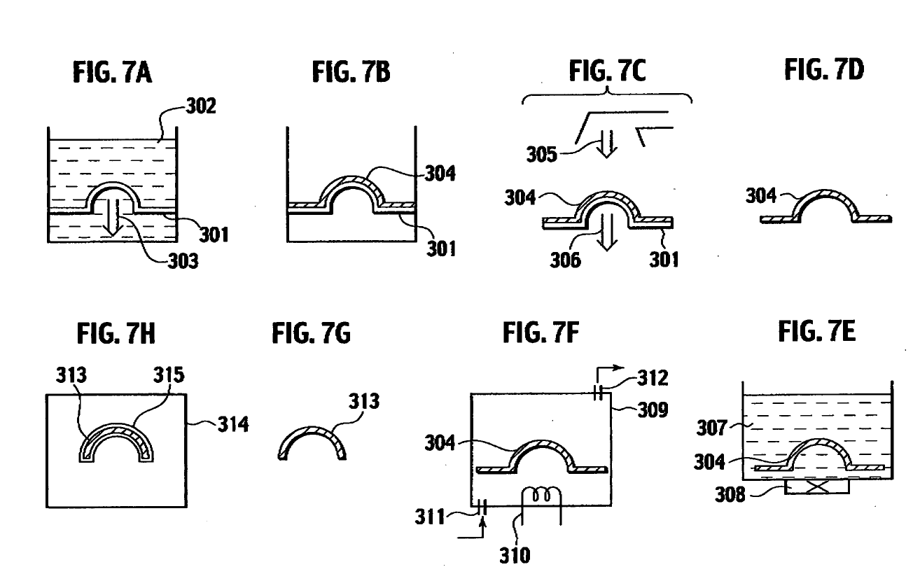

FIGS. 6 and 7A to 7H are explanatory diagrams of a production method according to a third embodiment.

At a first step 31 in FIG. 6, as shown in FIG. 7A, a previously formed mesh 301 having a center portion into a domical shape (hemispherical shape) is prepared. (Since the workpiece contracts due to a burning operation, the mesh may be formed larger than the size of the workpiece after the burning operation. For example, when the it is heated at 800° C., contraction of, for example, 25% in the longitudinal direction is taken into consideration, and the mesh may be formed larger by this value). The mesh 301 is put into dispersion liquid 302 into which mixture fiber of 90 wt % of linter (cotton fiber) 10 wt %+NEKP [Needle Bleach Kraft Pulp] (softwood fiber is made into pulp by kraft process and is further bleached) is dispersed, and the mixture fiber is milled into paper on the mesh 301. A reference number 303 represents a suction direction when paper is milled, and a reference number 304 in FIG. 7B represents milled paper. The mesh 301 can be made of metal such as brass, but the material is not limited to the value, and any strong, heat-resistance material can be used.

To remove moisture from the milled paper 304 on the mesh 301, hot air 305 (e.g., in a range of 100° C. to 200° C., as an example, at 150° C.) is blown on the milled paper 304 and the mesh 301 is vacuum-sucked from below at the same time as shown in FIG. 7C. A reference number 306 represents the vacuum-suction airflow.

At a second step 32 in FIG. 6, the milled paper 304 is detached from the mesh 301 as shown in FIG. 7D, and is immediately immersed in an alcohol solution 307 of phenol resin (phenol resin containing ratio is about 15 wt %) as shown in FIG. 7E, and the alcohol solution 307 impregnates the milled paper 304. At that time, the entire alcohol solution 307 of phenol resin is subjected to ultrasonic oscillation for about five minutes by an ultrasonic oscillator 308 so that the alcohol solution 307 fully impregnates into the milled paper 304.

The milled paper 304 is taken out from the solution 307 and sufficiently dried, and the milled paper 304 is then heated for about ten minutes at about 180° C. so that the phenol resin, which is a short molecule, is brought into a high polymer state.

Next, at a third step 33 in FIG. 6, as shown in FIG. 7F, the milled paper 304 impregnated with phenol resin is placed in a vacuum heating furnace 309, and is heated from a room temperature to 800° C. by a heater 310 in a substantially anoxic atmosphere (for example, nitrogen gas atmosphere). After the milled paper 304 is held for 30 minutes at 800° C., it is gradually cooled to the room temperature and is taken out from the furnace. With this step, the organic matter included in the milled paper 304 is carbonized. Thus, a large number of fine holes are formed in the milled paper 304 so as to be porous. A reference number 311 represents an introduction port for nitrogen gas or the like, and a reference number 312 represents a discharge port for nitrogen gas or the like.

Next, at a fourth step 34 in FIG. 6, as shown in FIG. 7G, a domical body of a porous carbide 313 is carved out by cutting. When paper is milled, if a small step portion is formed at a boundary between the conical shaped portion and the flat portion of the milled paper 304, it can be cut by a router or a laser cutter, or the like using the small step portion as a guideline, so it is possible to obtain a precise shape.

Next, at a fifth step 35 in FIG. 6, firstly, a (Japanese) lacquer coating material composed of a solution, which is obtained by diluting a purified lacquer solution with kerosene by weight ratio of 1:1, is applied to edges and entire surface of the porous carbide 313. Here, the lacquer coating material refers to an undiluted lacquer solution made by filtering, dispersing, and thermal dehydrating a raw lacquer so as to include about 5 wt % of moisture. The undiluted lacquer solution may be obtained by diluting an undiluted lacquer solution (name of product; MR Kurosugurome produced by Sato Kimimatsu Shoten, Co., Ltd.) composed of 80 wt % to 85 wt % of urushiol, 8 wt % to 12 wt % of polysaccharides, and 4 wt % to 5 wt % of moisture into 1 to 5 times. After applying the lacquer coating material on the porous carbide 313, in the fifth step 35, as shown in FIG. 7H, the porous carbide 313 is placed in a humidifying tank 314 and left at rest for 24 hours under an atmosphere at a temperature of 30° C. and a relative humidity of 60%.

After the porous carbide 313 is completely hardened, the same lacquer coating material is further applied to the edge portions and entire surface of the porous carbide 313. Then, again, it is placed in the humidifying tank 314 and is left at rest for 24 hours under the atmosphere 315 at a temperature of 30° C. and a relative humidity of 60%. The porous carbide 313 which is completely hardened again is sufficiently effective for filling the fine openings so that air leakage is prevented when the diaphragm is used as an acoustic diaphragm. A reference 315 in FIG. 7H represents a lacquer layer which works as a filling layer.

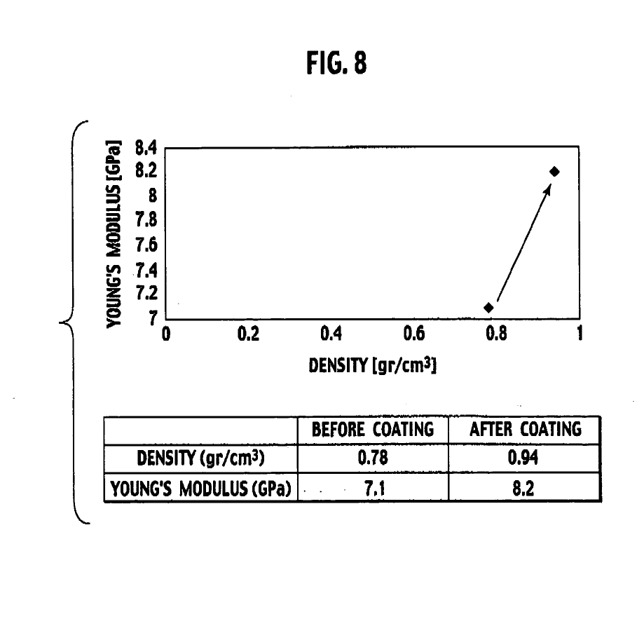

Further, increased weight of the porous carbide 313, which is completely hardened again after being left for about 24 hours under the atmosphere at about 30° C. and 60% (relative humidity) is about 20 wt % (compared to the porous carbide 313 before being coated by the lacquer coating material composed of a purified lacquer solution). However, the weight is within a range for use as required as an acoustic diaphragm and the Young's modulus increases about 15% from 7.1 GPa of the workpiece before coating to 8.2 GPa of the workpiece after coating (compared to the porous carbide 313 before being coated by the lacquer coating material). As a result, a sufficient strength to avoid damage in an assemble process of a speaker using the acoustic diaphragm can be obtained. FIG. 8 shows a relation between the Young's modulus and the density before and after coating. According to this sample, the thickness of the lacquer layer was within a range of about 1 μm to 20 μm and the average was 5 μm. This thickness is sufficient for the above described effect.

While it is preferable to use nitrogen gas as the anoxic atmosphere because it is inexpensive and is readily available, argon, high vacuum atmosphere, and the like can be used other than the nitrogen gas.

Here, urushiol is used as the lacquer. As other lacquers, laccol and thitsiol may be used. However, the obtained layers of those elements are lower in its strength compared to a layer made of urushiol. Thus, for an acoustic diaphragm requiring a certain degree of strength, urushiol is the most preferable. However, in the case of an acoustic diaphragm which does not require high degree of strength, laccol or thitsiol may be used in the present invention. According to this embodiment of the present invention, urushiol, laccol, and thitsiol are referred as a urushiol group for descriptive purposes. In addition, in all other embodiments of the present invention, “urushiol” may be understood as the “urushiol group”.

### Fourth Embodiment

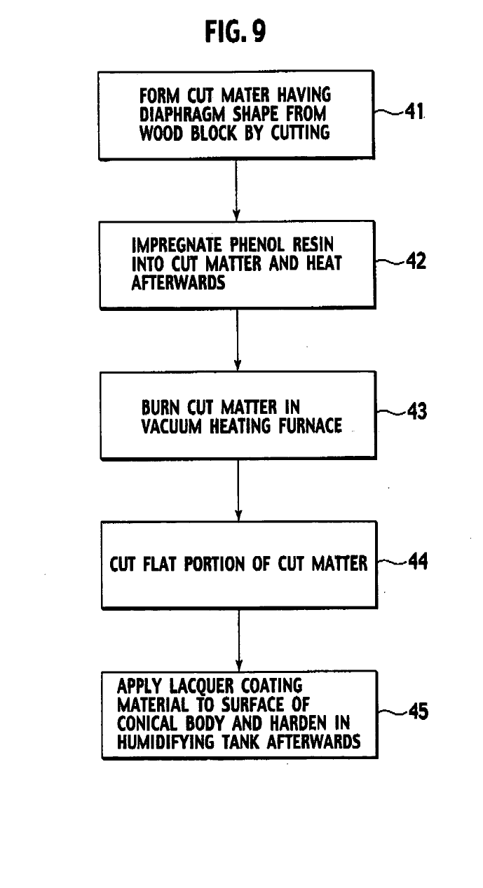

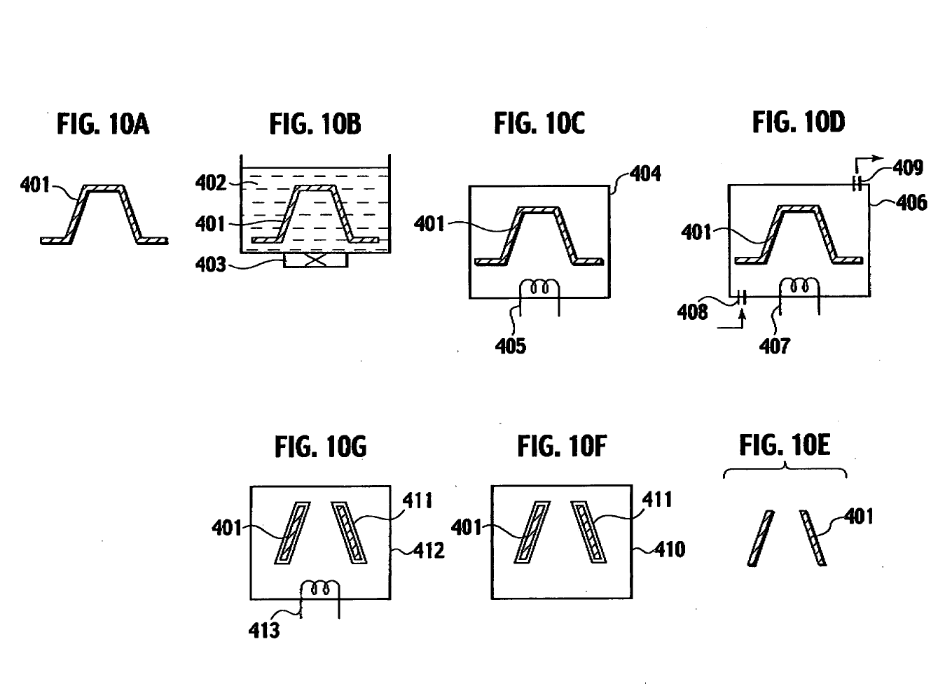

FIGS. 9 and 10A to 10G are explanatory diagrams of a production method according to the fourth embodiment.

At a first step 41 in FIG. 9, as shown in FIG. 10A, a sectionally hat-shaped cut matter 401, having a center portion, is previously formed into a conical shape (truncated shape). (Since the workpiece contracts due to a burning operation, the conical shaped portion may be formed larger than the size of the workpiece after the burning operation. For example, when it is heated at 800° C., contraction of, for example, 25% in the longitudinal direction is taken into consideration, and the mesh may be formed larger by this value).

At a second step 42 in FIG. 9, the cut matter 401 is immersed in an alcohol solution 402 of phenol resin (phenol resin containing ratio is about 15 wt %) as shown in FIG. 10B, and the alcohol solution 402 is impregnated into the cut matter 401. At that time, the entire phenol solution 402 is subjected to ultrasonic oscillation for about five minutes by an ultrasonic oscillator 403, so that the phenol solution 402 is fully impregnated into the cut matter 401.

The cut matter 401 is removed from the solution 402 and sufficiently dried. The cut matter 401 is placed in a heating furnace 404 and heated for about 15 minutes, for example, at about 180° C. by a heater 405 as shown in FIG. 10C, and the phenol resin, which is a short molecule, is brought into a high polymer state.

Next, at a third step 43 in FIG. 9, as shown in FIG. 10D, the cut matter 401 is placed in a vacuum heating furnace 406, and heated from a room temperature to 800° C. by a heater 407 in a nitrogen gas atmosphere. After the cut matter 401 is held for 30 minutes at 800° C., it is gradually cooled to the room temperature and is removed from the furnace. With this step, the organic matter included in the cut matter 401 is carbonized. Thus, a large number of fine holes are formed so that the cut matter 401 is porous. A reference number 408 represents an introduction port for nitrogen gas, and a reference number 409 represents a discharge port for nitrogen gas.

At a fourth step 44 in FIG. 9, as shown in FIG. 10E, the flat portion of a flange portion of the cut matter 401 is eliminated by cutting. When the cut matter 401 is cut in the first step, if a small step portion is formed at a boundary between the conical shaped portion and the flat portion of the cut matter 401. The cut matter 401 can be cut using the small step portion as a guideline, so it is possible to cut the flat portion accurately.

At a fifth step 45 in FIG. 9, firstly, a (Japanese) lacquer coating material composed of a solution, which is obtained by diluting a purified lacquer solution with kerosene by weight ratio of 1:1, is applied to predetermined portions of the cut matter 401. Here, the lacquer coating material refers to an undiluted lacquer solution which is made by filtering, dispersing, and thermal dehydrating a raw lacquer so as to include about 5 wt % of moisture. The undiluted lacquer solution may be obtained by diluting an undiluted lacquer solution (name of product; MR Kurosugurome produced by Sato Kimimatsu Shoten, Co., Ltd.) composed of 80 wt % to 85 wt % of urushiol, 8 wt % to 12 wt % of polysaccharides, and 4 wt % to 5 wt % of moisture into 1 to 5 times. After applying the lacquer coating material on the cut matter 401, in the fifth step 45, as shown in FIG. 10F, the cut matter 401 is placed in humidifying tank 410 and left at rest for 24 hours under an atmosphere at about 30° C. and relative humidity of 60%. Here, the predetermined portions represent two or more of the end face, front face, and rear face of the cut matter 401.

Further, as shown in FIG. 10G, the cut matter 401 is placed in a heating furnace 412 and heated by a heater 413, for example, for 30 minutes at 150° C. The process shown in FIGS. 10F and 10G are repeated as needed in order to achieve a sufficient filling effect of the fine holes. When an efficient filling effect is achieved, air leakage can be completely prevented when it is used as an acoustic diaphragm. Here, a reference 411 shown in FIGS. 10F and 10G represents a lacquer layer as a filling layer.

Since the lacquer coating material permeates into holes of the porous carbide with the solution and forms a film by being applied to the porous carbide or immersing the porous carbide in the solution, the occurrence of fractures of the carbonized diaphragm will be remarkably reduced. Further, since the thickness of the lacquer coating film is thin, a lightweight and strong carbonized material, without increasing the weight of the diaphragm too much, is realized. In addition, since the lacquer coating film is provided, a diaphragm having high internal losses is realized. Accordingly, when the diaphragm is used as a speaker, distortion is prevented and generated strain component are absorbed so that frequency characteristics are improved.

According to the present embodiment, lacquer coating material of the foregoing purified lacquer solution is used. However, it is not limited to the diluted condition and a sufficient filling effect can be achieved with a condition that a weight rate of lacquer and kerosene is set, for example, 1:10.

### Fifth Embodiment

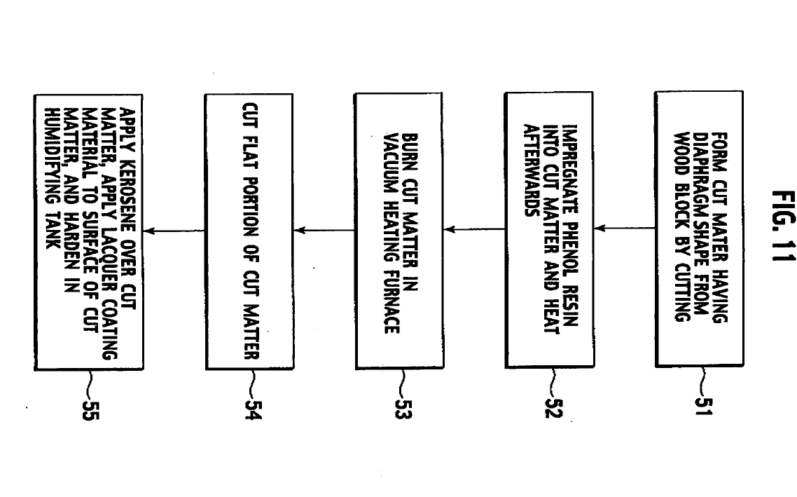

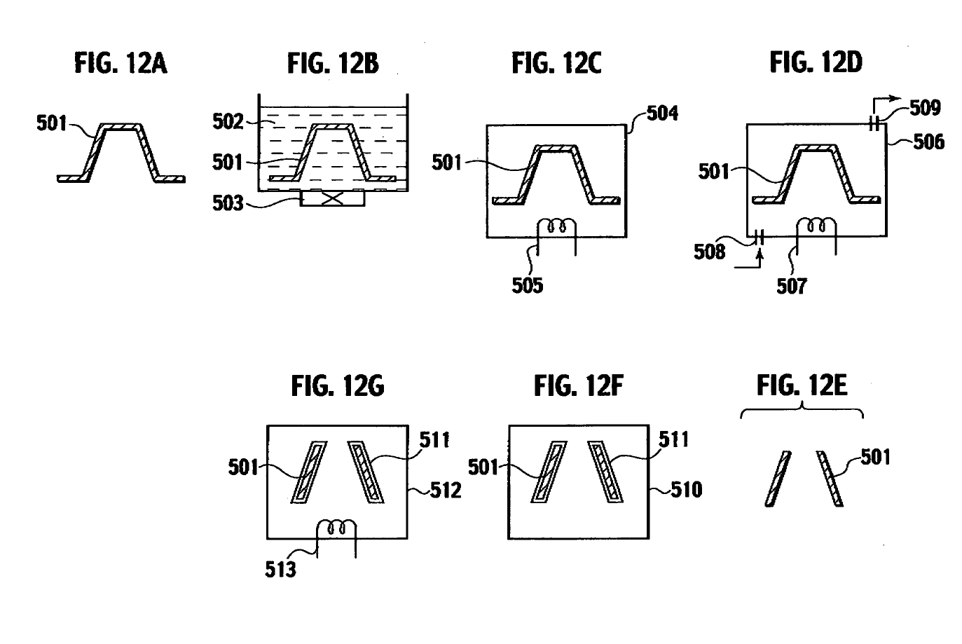

Next, a fifth embodiment of the present invention will be described. FIGS. 11 and 12A to 12G are explanatory diagrams of a product method according to the fifth embodiment.

At a first step 51 in FIG. 11, a block of a Japanese cypress, which is a softwood, is cut to obtain a substantially hat shaped cut matter 501 having a conical (truncated) portion. (Since the conical portion is contracted due to a burning operation, this portion is formed larger than the size thereof after the burning operation. In this case, since it is heated at 800° C., contraction of 25% is taken into consideration, and the portion is formed larger by this value).

At a second step 52 in FIG. 11, as shown in FIG. 12B, the cut matter 501 is immersed in an alcohol solution 502 of phenol resin (ratio of phenol resin is about 15%) and impregnated with the solution 502. The entire phenol solution 502 in which the cut matter 501 is impregnated is subjected to ultrasonic oscillation for about five minutes by an ultrasonic oscillator 503 so that the solution 502 fully impregnates the cut matter 501.

The cut matter 501 is taken out from the solution 502 and is sufficiently dried. It is placed in a heating furnace 504 as shown in FIG. 12C and is heated for about 15 minutes at about 180° C. by a heater 505, and the phenol resin, which is a short molecule, is brought into a high polymer state.

Next, at a third step 53 in FIG. 11, as shown in FIG. 12D, the cut matter 501 in which phenol resin is brought into a high polymer state is placed in a vacuum heating furnace 506, and it is heated from a room temperature to 800° C. by a heater 507 in a nitrogen gas atmosphere. After the cut matter 501 is held for 30 minutes at 800° C., it is gradually cooled to the room temperature and is taken out from the furnace. With this step, the organic matter included in the cut matter 501 is carbonized. Thus, a large number of fine holes are formed in the cut matter 501 so that the cut matter 501 is porous. A reference number 508 represents an introduction port for nitrogen gas, and a reference number 509 represents a discharge port for nitrogen gas.

At a fourth step 54 in FIG. 11, as shown in FIG. 12E, the flat portion of the cut matter 501 is eliminated by cutting. At the time of the cutting operation at the first step, if a small step portion is previously formed between the conical portion and the flange portion of the cut matter 501, it can be cut using the small step portion as a guideline, so it is possible to precisely eliminate the flange portion accurately.

At a fifth step 55 in FIG. 11, firstly, after kerosene is applied to predetermined portions of the cut matter 501, a (Japanese) lacquer coating material composed of a solution, which is obtained by diluting a purified lacquer solution with kerosene by weight ratio of 1:1, is applied to predetermined portions of the cut matter 501. Here, the lacquer coating material refers to an undiluted lacquer solution which is made by filtering, dispersing, and thermal dehydrating a raw lacquer so as to include about 5 wt % of moisture. The undiluted lacquer solution may be obtained by diluting an undiluted lacquer solution (name of product: MR Kurosugurome produced by Sato Kimimatsu Shoten, Co., Ltd.) composed of 80 wt % to 85 wt % of urushiol, 8 wt % to 12 wt % of polysaccharides, and 4 wt % to 5 wt % of moisture into 1 to 5 times. After applying the lacquer coating material on the cut matter 501, in the fifth step 55, as shown in FIG. 12G, the cut matter 501 is placed in humidifying tank 510 and left at rest for 24 hours under an atmosphere at about 30° C. and relative humidity of about 60%.

The processes shown in FIGS. 12F and 12G are repeated as needed in order to achieve a sufficient filling effect. When an efficient hole filling effect is achieved, air leakage can be completely prevented when the cut matter is made as an acoustic diaphragm. Here, a reference 511 in FIGS. 12F and 12G represents a lacquer layer as a filling layer.

According to the acoustic diaphragm of the present embodiment, a complete hole filling effect can be obtained. Further, kerosene prevents the lacquer coating material from permeating into the diaphragm so that lacquer is thin at the inner portion of the diaphragm and thick at the outer portion. It is effective for reducing the weight of the diaphragm and increasing the internal losses. As a result, an excellent acoustic diaphragm is achieved. In other words, when the lacquer coating material is applied, it permeates into the holes of the porous carbide so that the probability of fracture of the carbonized diaphragm is remarkably reduced. Further, since the phenol resin coating material permeates into the holes located near the surface of the porous carbide and forms a phenol resin membrane inside of the holes near the surface of the porous carbide, interior spaces which are not impregnated with the phenol resin coating material. Accordingly, the strength of the carbonized material, as an acoustic diaphragm, is improved while weight saving is maintained and weight of the acoustic diaphragm is not increased so much. When the diaphragm is used as a speaker, due to an increase of internal losses because of the phenol resin layer, distortion is prevented and generated strain components are absorbed so that frequency characteristics are improved. In this case, it was found that the thickness of the diaphragm was about 1 mm, and a lacquer layer was concentrated at the portion near the surfaces, about 20% of the length (depth) of the thickness of the diaphragm.

Since phenol resin is a material that can withstand long term use under a high-temperature environment of over 100° C., an acoustic diaphragm according to the present invention can be applied to a high-power speaker. Since phenol resin is highly resistant to humidity, the present invention can provide a speaker which can stand long term use in a high-humidity environment.

Further, the present invention provides an acoustic diaphragm that visually has an expensive appearance. The color of the diaphragm can be changed by adding a substance such as copper and artistic (beautiful) appearance similar to “MAKI-e” (Maki-e is Japanese gold or silver lacquer sprinkled with metal powder as a decoration using a makizutsu or a kebo brush) can be obtained so that the present invention can provide a picturesque speaker.

Further, the lacquer coating material does not contain a synthetic resin such as petroleum solvents, so that it is effective for use in a global environment, similar to a case of using natural materials for a diaphragm having a high carbonization ratio.

Further, when the end face of the workpiece is included as the portion where the lacquer coating material is applied, air leakage can be prevented more effectively.

According to the present embodiment, kerosene is applied before lacquer is applied, however, the present embodiment is not limited to a hydrocarbon solvent such as kerosene and any other liquid, such as liquid composed of water and ethanol, may be employed if it evaporates under a condition so that the lacquer is hardened.

### (An Example of a Speaker)

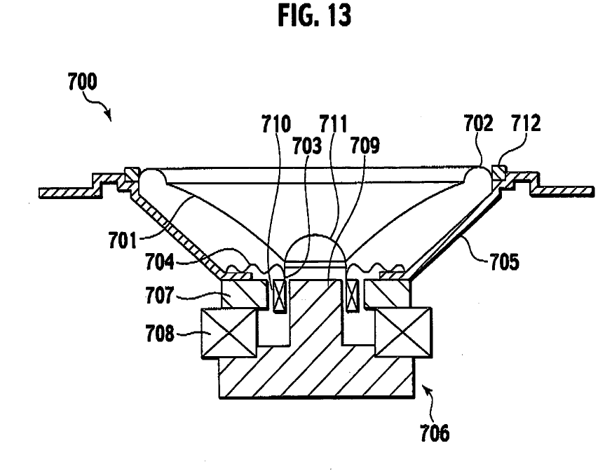

In FIG. 13, a rubber edge 702 having a predetermined shape is adhered to an entire outer periphery of a conical acoustic diaphragm 701 formed by any one of the production methods according to the first to the five embodiments, and a bobbin of a voice coil 703 having a predetermined shape (a predetermined damper 704 is previously adhered to the bobbin) is adhered to a center of the acoustic diaphragm 701.

These integral three parts are attached by adhesion to a predetermined speaker housing 705 (a predetermined magnetic circuit 706 is previously provided). A conductive metal wire (not shown) is pulled out from the voice coil 703. The metal wire is connected to a terminal (not shown, and it is previously insulated from the metal housing 705) mounted on the housing 705.

The magnetic circuit 706 includes a ring-shaped plate 707, a ring-shaped magnet 708, a pole 709, and the like. The voice coil 703 is loosely inserted into a magnetic gap 710 formed between the plate 707 and the pole 709. The speaker is completed by polarizing the magnet 708. A reference number 711 represents a dust cap for preventing foreign matter from entering the voice coil 703. A reference number 712 represents an annular gasket for pressing an end of the edge 702.

As compared with a speaker having a wood acoustic diaphragm with the same shape, the speaker 700 has a high carbonization ratio, and has excellent acoustic properties with a clear reproduced sound and small distortion.

### Sixth Embodiment

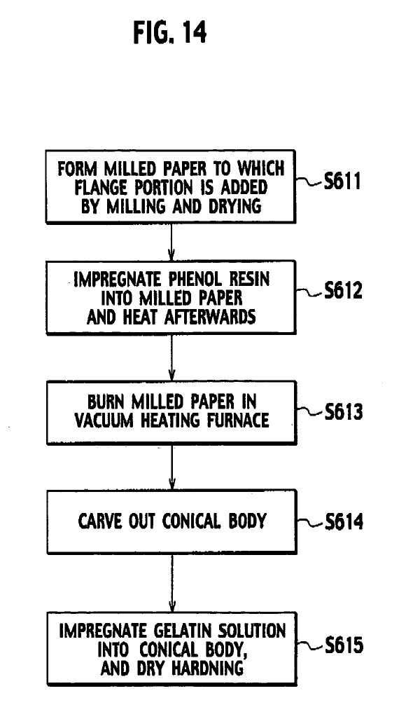

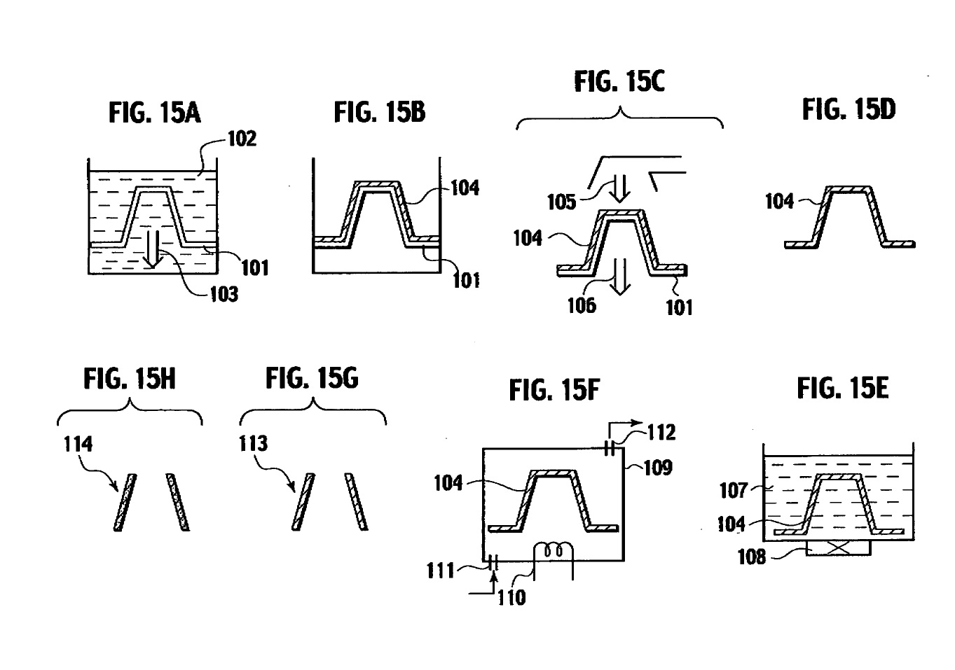

Next, a sixth embodiment of the present invention will be described with reference to FIGS. 14 and 15A to 15H. The sixth embodiment is different in the fifth step S615 shown in FIG. 14 from the first embodiment shown in FIG. 1. Thus, steps from the first step S611 to the fourth step S614 shown in FIG. 14 are the same as steps from the first step S11 shown in FIG. 1 to the fourth step S14 and thus will not be described further.

The sixth embodiment is different in the step shown in FIG. 15H from the first embodiment shown in FIG. 2. Specifically, the sixth embodiment is different from the first embodiment in steps after the formation of the carbide conical body 113. Thus, FIG. 15A to FIG. 15G are the same as FIG. 2A to FIG. 2G and thus will not be described further.

In the fifth step S615 of the sixth embodiment, the end face and the entire surface of the carbide conical body 113 is impregnated with gelatin aqueous solution and is dried at a normal temperature for 24 hours as shown in FIG. 15H. Gelatin aqueous solution may be, for example, aqueous solution including substantially 5 wt % of gelatin. This may be aqueous solution obtained by diluting G-0628K made by Nitta Gelatin Inc. with water to obtain about 5 wt % for example. Thereafter, the carbide conical body 113 is dried in atmosphere of substantially 40 degrees C. for 30 minutes to cure gelatin almost completely to form the body cone part 114 of the acoustic diaphragm.

When gelatin cures almost completely, a sufficient sealing effect is obtained and air leakage during the use of acoustic diaphragm can be prevented effectively. It is noted that, when gelatin is used for the impregnated body cone part 114, the weight increases by substantially 10 wt % when compared the carbide conical body 113 prior to the impregnation with gelatin but the increase is approximately within a weight range required for the acoustic diaphragm.

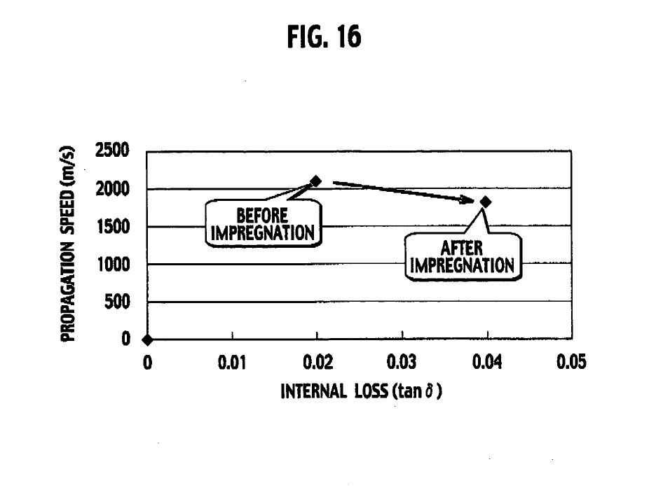

FIG. 16 shows a relation between a sound propagation speed and an internal loss tan δ before and after the impregnation with gelatin. As is clear from FIG. 16, the internal loss tan δ increases from 0.02 before coating to 0.04 after impregnation to show a substantially 50% improvement when compared with the conical body 113 before the impregnation with gelatin. As is also clear from FIG. 16, the propagation speed generally significantly decreases with an increase in the internal loss of the material but even the increase in the internal loss causes a small decrease in the propagation speed.

In the method for manufacturing the acoustic diaphragm according to the sixth embodiment, the fifth step S615 causes the surface or the end face of the carbide conical body 113 of porous carbide to be impregnated with gelatin aqueous solution to permeate the solution the pores in the porous carbide, thereby forming a gelatin film on the surface and the interior of carbide conical body 113.

The formation of the gelatin film can improve the strength of the acoustic diaphragm and can enhance the internal loss. Thus, the strain component of a speaker during the use of the acoustic diaphragm can be absorbed to improve the frequency characteristic.

Although the sixth embodiment uses gelatin aqueous solution having a gelatin concentration of 5 wt %, the invention is not limited to this concentration. Thus, the gelatin aqueous solution having a gelatin concentration in a range from substantially 1 wt % to substantially 20 wt % may be appropriate. A gelatin concentration of 1 wt % or less causes a small amount attached to a burned matter during the impregnation to cause an insufficient sealing effect by gelatin. A gelatin concentration of 20 wt % or more on the other hand causes a high water-soluble viscosity to cause an uneven surface of the burned matte during the impregnation.

Since gelatin aqueous solution tends to cause foam, foam formation can be effectively suppressed by adding ethanol of about 0.1 wt % for example to the solution. It is also effective to add surfactant of sodium lauryl sulfate of about 0.01 wt %.

In the sixth embodiment, an example was described in which the fifth step S615 used gelatin aqueous solution. However, since gelatin is protein and structured so that a molecule includes a hydrophobic (lipophilic) part repelling water and a hydrophilic part, gelatin also may be mixed with solvent other than water (warm water) to have a solution-like form (including the emulsion state). Preferred gelatin may be material having a low refining degree (e.g., gelatin G-0628K made by Nitta Gelatin Inc.). It is noted that the expression of “having a low refining degree” refers to material including impurities such as a sulfate group (SO₄) and chlorine (Cl) for example.

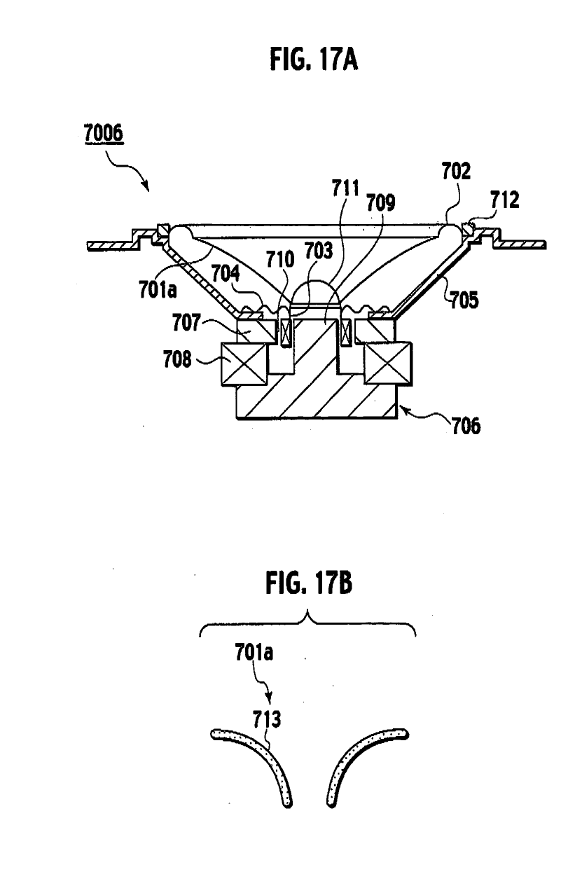

FIG. 17A shows a speaker 7006 according to the sixth embodiment. The speaker 7006 uses, instead of the acoustic diaphragm 701 of the speaker 700 shown in FIG. 13, the body cone part 114 shown in FIG. 15H formed by the sixth embodiment as the acoustic diaphragm 701a.

With regard to speaker 7006, those having the same structures as those of the speaker 700 of FIG. 13 are denoted with the same reference numerals and thus will not be described further.

FIG. 17B is a partial expanded view illustrating an example of the acoustic diaphragm 701a shown in FIG. 17A. The acoustic diaphragm 701a shown in FIG. 17B includes a diaphragm-shaped porous carbide 713 formed by carbide of natural material and phenol resin. At least one of the interior and the surface of the porous carbide 713 includes a gelatin component attached to the porous matter 713 due to the impregnation with gelatin solution. This gelatin component is buried in the pore of the porous carbide 713 to form a gelatin film in the porous carbide 713 to improve the strength of the resultant acoustic diaphragm and to enhance the internal loss. This can consequently improve the acoustic characteristic of the speaker using the acoustic diaphragm 701a.

### Seventh Embodiment

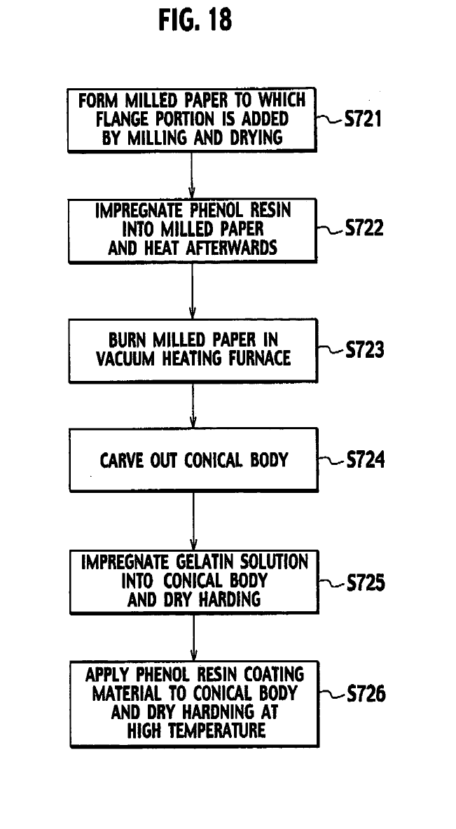

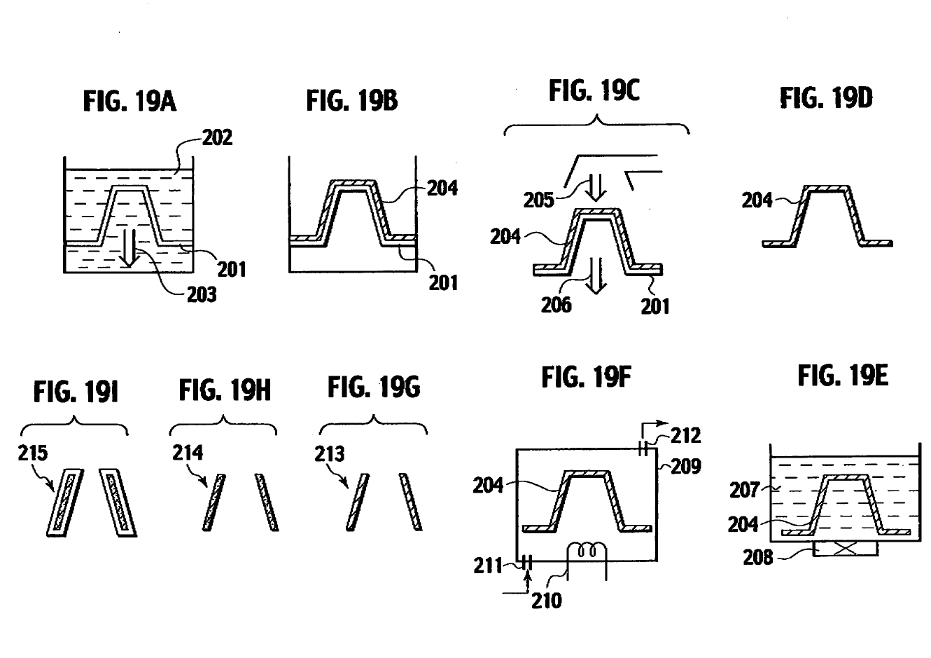

A seventh embodiment of the present invention will be described with reference to FIGS. 18 and 19A to 19I. The seventh embodiment is different from the second embodiment shown in FIG. 4 in the fifth step S725 and the sixth step S726 shown in FIG. 18. Thus, steps from the first step S21 to the fourth step S24 shown in FIG. 4 are the same as those of the first step S721 to the fourth step S724 shown in FIG. 18 and thus will not be described further.

The seventh embodiment is also different from the second embodiment shown in FIG. 5 in the steps shown in FIGS. 19H and 19I. Specifically, the seventh embodiment is different from the second embodiment in the step after the shape formation of the body cone part 213. Thus, FIG. 19A to FIG. 19G are the same as FIG. 5A to FIG. 5G and thus will not be described further.

In the fifth step S725 of FIG. 18, the end face and the entire surface of the porous carbide conical body 213 are impregnated with gelatin aqueous solution as shown in FIG. 19H. The gelatin aqueous solution may be, for example, aqueous solution including gelatin of substantially 3 wt %. This is aqueous solution obtained, for example, by diluting G-0628K made by Nitta Gelatin Inc. with water to have about 3 wt %. Thereafter, the porous carbide conical body 213 is dried in atmosphere of substantially 40 degrees C. to cure gelatin to obtain the body cone part 214.

In the sixth step S726 of FIG. 18, the end face and the entire surface of the conical body 214 are coated with coating liquid of phenol resin (having a phenol resin concentration of substantially 10 wt % and using solvent of ethanol) and are dried. Thereafter, the conical body 214 is heated in atmosphere of substantially 60 degrees C. for substantially 30 minutes and is further heated in atmosphere of substantially 105 degrees C. for substantially 3 minutes to cure the phenol resin coating liquid almost completely to obtain the conical body 215 as shown in FIG. 19I.

When phenol resin coating liquid is cured almost completely, a strong film (resin film) is formed on the surface. Thus, the resultant acoustic diaphragm has an increased strength to provide an easy handling in a manufacturing operation and to provide a sufficient strength to prevent a speaker from being damaged during the assembly. Furthermore, the impregnation of the conical body 213 with gelatin solution followed by the addition of the phenol resin coating to the conical body 214 by the impregnation can provide the resultant acoustic diaphragm with a higher sound propagation speed. Thus, a slightly-reduced sound propagation speed can be recovered to improve the frequency characteristic of the speaker.

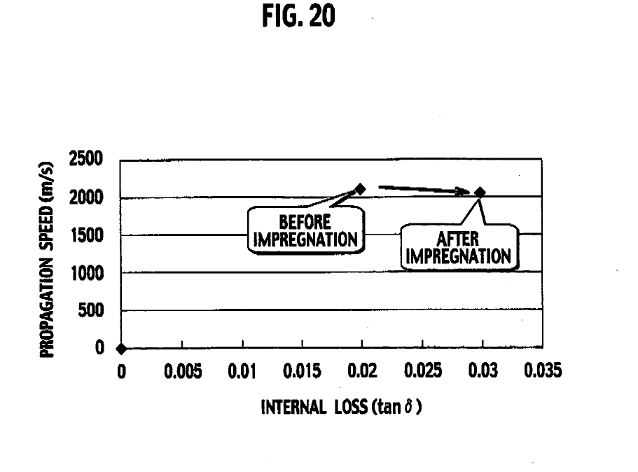

FIG. 20 shows a relation between the sound propagation speed and the internal loss tan δ of the acoustic diaphragm manufactured by the manufacture method shown in the seventh embodiment. In FIG. 20, the acoustic diaphragm is evaluated with regard to a case where the impregnation with phenol resin is carried out and a case where the impregnation with gelatin is not carried out. The internal loss tan δ using the conical body 214 coated with phenol resin increases from 0.02 before the coating to 0.03 after the impregnation and shows an improvement of substantially 30% when compared with the conical body 213 not yet impregnated with gelatin and phenol resin. As shown in the graph of FIG. 20, the decrease in the propagation speed is small even when the internal loss is increased.

According to the seventh embodiment, the sixth step S726 of FIG. 18 can add phenol resin to the surface and the interior of the conical body 214 including gelatin (e.g., impregnation or coating) to form a phenol resin film to enhance the internal loss of the acoustic diaphragm to improve the frequency characteristic of the resultant speaker. Since phenol resin is material that can be used for a long time even under an environment having a high temperature exceeding 100 degrees C., an acoustic diaphragm and a speaker can be obtained that can endure an environment having a high output and a high humidity for a long time.

According to the seventh embodiment, the second step S722 of FIG. 18 causes a part or the entirety of the interior of the work to be impregnated with solution including phenol resin to add the solution to the work to subsequently carbonize the work, thus providing high carbonization rate acoustic diaphragms having different densities depending on the degree of attached phenol resin, respectively. Furthermore, the attached amount of the phenol resin coating material used for sealing the work in the second and sixth steps S722 and S726 can be increased or decreased to provide finally-obtained acoustic diaphragms with different properties.

As a result, the diaphragm property can have a change (i.e., the acoustic diaphragm can have an increased design freedom). When the acoustic diaphragm is used as a speaker, the acoustic diaphragm can have a propagation speed set in a range of high values to have a better acoustic characteristic. It is noted that the addition of phenol resin to the work in steps S722 and S726 may be carried out not only by impregnation but also by atomizing, spraying, coating, or injection.

Although the seventh embodiment has carried out the impregnation with gelatin and the drying to subsequently carry out the impregnation and curing of phenol resin, the impregnation and curing of phenol resin (the formation of a phenol resin film) also may be followed by the impregnation and drying of gelatin. The latter order can increase the curing temperature of phenol resin and thus can reduce the curing time. The latter order also can allow a gelatin layer to be left on the surface and thus can adjust the acoustic quality of the resultant speaker depending on a preference when compared with the former example in which the surface has thereon the phenol resin layer. In any of the cases, the formation of the phenol resin film after the carbonization on the body cone part is carried out in at least any of the interior and the surface of the body cone part.

Although the seventh embodiment has showed an example in which solution made of ethanol solvent including 10 wt % of phenol resin was used for the coating, the invention is not limited to this. The concentration of the solution can be appropriately set depending on the characteristic of a required diaphragm. An appropriate value of the concentration is appropriately set depending on the weight or property required for the acoustic diaphragm for example. The seventh embodiment also may use gelatin solution using solvent other than water (warm water).

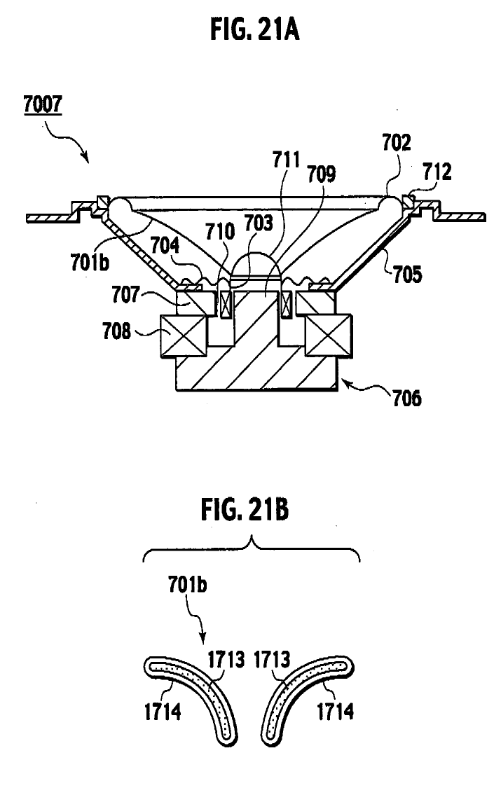

FIG. 21A shows a speaker 7007 according to the seventh embodiment. The speaker 7007 uses, instead of the acoustic diaphragm 701 of the speaker 700 shown in FIG. 13, the conical body 215 shown in FIG. 19I formed by the seventh embodiment as an acoustic diaphragm 701b.

Those in the speaker 7007 having the same structures as those of the speaker 700 of FIG. 13 are denoted with the same reference numerals and will not be described further.

FIG. 21B shows an example of the partial expanded view of the acoustic diaphragm 701b shown in FIG. 21A. The acoustic diaphragm 701b shown in FIG. 21B includes a diaphragm-shaped porous carbide 1713 formed by carbide of natural material and phenol resin (resin film). The acoustic diaphragm 701b is structured so that at least one of the interior and the surface of the porous carbide 1713 is attached with a gelatin component of the gelatin aqueous solution used in the impregnation in the fifth step S725 (see FIG. 19E). The gelatin component is buried in the pore of the porous carbide 1713 to form a gelatin film in the porous carbide 1713 to improve the strength of the resultant acoustic diaphragm and to enhance the internal loss. Furthermore, the surface of the porous carbide 1713 has thereon hardened phenol resin (phenol resin film) 1714. This can provide the acoustic diaphragm 701b that can endure an environment having a high output and high humidity for a long time.

The acoustic diaphragm 701b formed by the seventh embodiment includes the hardened material of phenol resin (resin film) 1714. Thus, the speaker 7007 including the acoustic diaphragm 701b and the acoustic diaphragm 701b can endure an environment having a high temperature and high humidity for a long time.

### Eighth Embodiment

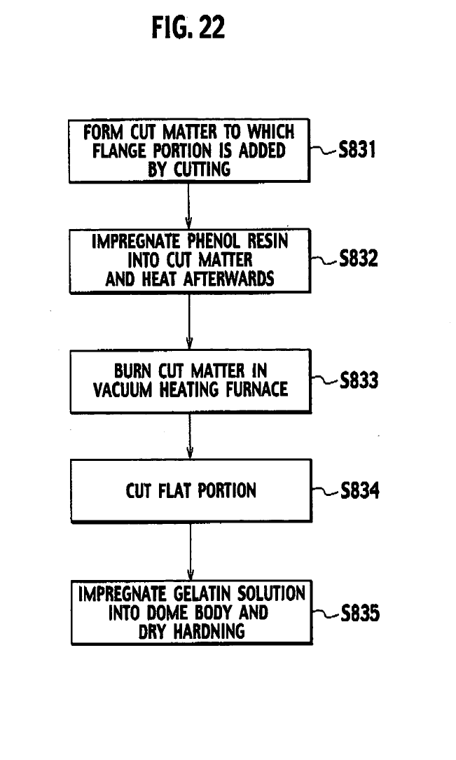

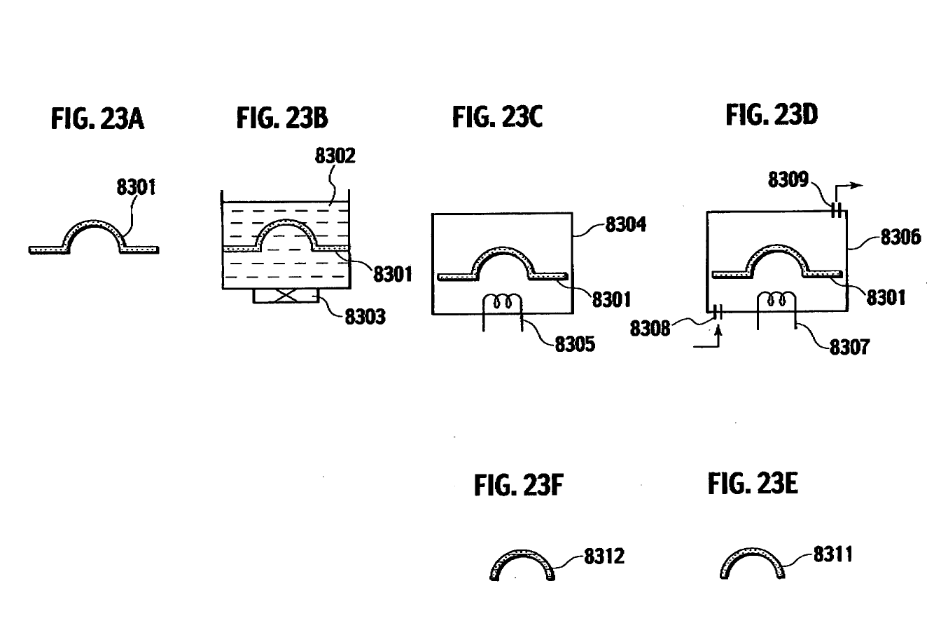

A method for manufacturing an acoustic diaphragm according to the eighth embodiment will be described with reference to FIG. 22 and FIG. 23A to 23F. The first step S831 of FIG. 22 cuts off a block of hinoki cypress of softwood to obtain a cut matter 8301 as shown in FIG. 23A that has a dome-like shape (semicircular shape). It is noted that the cut matter 8301 having a dome-like shape before a burning process has a larger size than that after the burning process in order to take into consideration the ratio of the shrinkage. In a case where the cut matter 8301 is heated at 800 degrees C., about 25% volume shrinkage is taken into consideration and thus the cut matter 8301 before the burning process has a proportionally-increased size.

The second step S832 of FIG. 22 causes the cut matter 8301 to be immersed in alcohol solution 8302 of phenol resin (having a phenol resin content rate of substantially 15 wt %) as shown in FIG. 23B to cause the cut matter 8301 to be impregnated with the solution 8302. During this process, the entire alcohol solution 8302 of phenol resin is subjected by an ultrasonic transducer 8303 to an ultrasonic oscillation for 5 minutes for example so that the solution 8302 deeply enters the cut matter 8301.

Then, the cut matter 8301 is removed from the solution 8302 and is dried sufficiently to form a phenol resin film on at least the interior or the surface of the cut matter 8301. As shown in FIG. 23C, the cut matter 830 is placed in a heating furnace 8304 to heat the cut matter 8301 by a heater 8305 at a temperature of about 180 degrees C. for example for 15 minutes to cause phenol resin having a short molecule to have a high molecule.

The third step S833 of FIG. 22 causes the cut matter 8301 of phenol resin having a high molecule to be placed in a vacuum heating furnace 8306 as shown in FIG. 23D to heat the cut matter 8301 in nitrogen gas atmosphere by the heater 8307 from the normal temperature to 800 degrees C. After maintaining the temperature at 800 degrees C. for 30 minutes, then the cut matter 8301 is gradually cooled to a normal temperature and is removed from the furnace. This step carbonizes the organic substance included in the cut matter 8301 to change the cut matter 8301 into porous carbide including a great number of minute pores. It is noted that the reference numeral 8308 denotes an opening through which nitrogen gas is introduced and the reference numeral 8309 denotes an outlet of nitrogen gas.

The fourth step S834 of FIG. 22 causes, as shown in FIG. 23E, the flat part of the cut matter 8301 to be cut off to remove a body dome part 8311 as a dome part of the acoustic diaphragm. It is noted that, when the cutting process of the first step S831 previously forms an uneven part at the boundary between a small dome-like shape part and a flat part, the uneven part can be used as an indicator at which the cutting is carried out and thus the flat part can be cut accurately.

The fifth step S835 of FIG. 22 causes the end face and the entire surface of the body dome part 8311 to be impregnated with gelatin aqueous solution as shown in FIG. 23F. The gelatin aqueous solution can be, for example, aqueous solution having a gelatin concentration of substantially 5 wt % (e.g., aqueous solution obtained by diluting G-0628K made by Nitta Gelatin Inc. with water to have about 5 wt %).

After the solution is dried at the normal temperature for 24 hours, the solution is dried in atmosphere of substantially 40 degrees C. for 30 minutes to prepare the body dome part 8312 almost completely supplied with gelatin. The body dome part 8312 almost completely supplied with gelatin has a sufficient sealing effect and can prevent air leakage of the resultant acoustic diaphragm. Furthermore, gelatin aqueous solution permeates pores of the body dome part 8312 made of porous carbide to form a gelatin film on the interior and the surface of the carbide to improve the strength of the resultant acoustic diaphragm. Furthermore, the gelatin film can enhance the internal loss of the body cone part to absorb the strain component of the resultant acoustic diaphragm of the speaker, thus improving the frequency characteristic.

Since gelatin can flexibly expand and contract in accordance with the deformation of the body dome part 8312 caused by the oscillation, a small mechanical distortion is caused and thus sound can be transmitted in a favorable manner.

Although the eighth embodiment has used gelatin aqueous solution, another gelatin solution also may be used that is obtained by dissolving gelatin in solvent other than water (warm water) to have a solution-like form (including the emulsion state). Preferred gelatin has a low refining degree.

In the eighth embodiment, solution including phenol resin is attached to the cut matter 8301 of FIG. 23B while adjusting the attached amount to provide, when the cut matter 8301 is carbonized, high carbonization rate acoustic diaphragms (body dome parts 8311) having different degrees of attached phenol resin, respectively. In FIG. 23F, the attached amount of the phenol resin coating material used for sealing the body dome part 8301 also can be increased or decreased to provide finally-obtained acoustic diaphragms with different properties. As a result, the diaphragm property can have a change (i.e., the acoustic diaphragm can have a wider design freedom). When the acoustic diaphragm is used as a speaker, the acoustic diaphragm can have a propagation speed set in a range having higher values, thus providing a better acoustic characteristic. It is noted that the addition of alcohol solution of phenol resin to the body dome part 8301 of FIG. 23B may be carried out not only by impregnation but also by atomizing, spraying, coating, or injection.

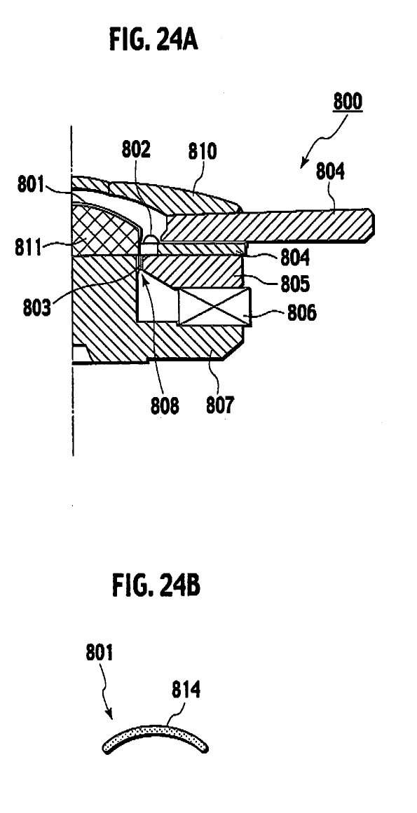

The speaker 800 according to the eighth embodiment uses the body dome part 8312 shown in FIG. 23F as the acoustic diaphragm 801. For example, the speaker 800 according to the eighth embodiment is structured, as shown in as shown in FIG. 24A, so that the entire outer circumference of the dome-like-shaped acoustic diaphragm 801 is attached with a rubber edge 802 having a predetermined shape to adhere a voice coil and a voice coil bobbin having a predetermined shape to the outer circumference of the acoustic diaphragm 801. These three integrated members are attached to a predetermined speaker housing 804.

The speaker housing 804 is previously attached with a top plate 805, a magnet 806, and a yoke 807 that are predetermined magnetic circuit members. Through the voice coil 803, an energization metal wire (not shown) is drawn and is connected to a terminal bobbin (not shown) attached to the housing 804. The terminal bobbin is previously insulated from the metal housing 804.

The magnetic circuit is composed of a doughnut-like top plate 805, a doughnut-like magnet 806, and a yoke 807 for example. The top plate 805 and the yoke 807 have therebetween a magnetic gap 808 to which the voice coil 803 is loosely inserted. When the magnet 806 is magnetized, the speaker is completed. It is noted that the reference numeral 810 denotes a diffuser for diffusing sound widely. The reference numeral 811 denotes noise absorbing material that absorbs unnecessary vibration noise.

When the speaker 800 shown in FIG. 24A is compared with a speaker having a wooden acoustic diaphragm formed to have the same shape, the speaker 800 has a high carbonization rate and provides a favorable acoustic characteristic through which clear reproduced sound having small clear distortion is obtained.

FIG. 24B shows an example of a partial expanded view of the acoustic diaphragm 801 shown in FIG. 24A. The acoustic diaphragm 801 shown in FIG. 24B includes a diaphragm-shaped porous carbide 814 formed by carbide of natural material and phenol resin. At least one of the interior and the surface of the porous carbide includes a gelatin component. The gelatin component is buried in the pore of the porous carbide 814 to form a gelatin film in the porous carbide 814 to improve the strength of the resultant acoustic diaphragm and to enhance the internal loss. As a result, the speaker using the acoustic diaphragm 801 can have an improved acoustic characteristic. It is noted that, since gelatin can flexibly expand and contract in accordance with the deformation of the diaphragm 801 caused by the acoustic oscillation, a small mechanical distortion is caused and thus sound can be transmitted in a favorable manner. It is noted that the addition of gelatin in the respective embodiments may be carried out not only by impregnation but also by atomizing, spraying, coating, or injection.

In the sixth embodiment to the eighth embodiment, “gelatin” in coating material (solution) including gelatin means high molecule substance prepared by subjecting hardly-soluble collagen (one type of protein) to a heating processing in acid or alkaline atmosphere. The high molecule substance means a straight-chain high molecule that generally has a bar-like shape corresponding to 1000 amino acids and that can be dissolved in warm water. Although gelatin water (warm water) solution frequently generates bubbles, bubbling can be prevented in coating and impregnation processes by adding a small amount of surfactant or methanol to the solution as required. Although the concentration of the gelatin solution is changed depending on a purpose, the concentration of the gelatin solution is desirably in a range from about 1 wt % to about 20 wt %. When coated and dried gelatin solution needs to have an improved weather resistance for example, aldehyde-base cross-linking agent also can be used.

In the sixth embodiment to the eighth embodiment, a burned work is coated or impregnated with coating material consisting of solution including gelatin for example. As a result, a gelatin film (the second film) can be formed on at least any of the hole and the surface of the carbide to realize the prevention of air leakage, an improved strength, and an enhanced internal loss.

Gelatin and phenol resin coating material can be coated on any part so long as the coated part can achieve certain purposes such as a purpose of effectively preventing air leakage and providing uniform physical properties such as an internal loss. However, since an end face of the work includes openings at ends of a great number of minute cells (e.g., wood and natural fibers), it is particularly effective to coat the end face of the work with gelatin and phenol resin coating material.

According to the sixth embodiment to the eighth embodiment, the interior or the surface of the work manufactured using natural material is impregnated with solution including phenol resin to form a resin film including phenol resin. When this resin film is heated and is subsequently carbonized, high carbonization rate acoustic diaphragms are obtained that have different densities depending on the degree at which phenol resin enters the work, respectively. Furthermore, the amount of gelatin or phenol resin for sealing holes or the like in the carbonized work (sealing processing) is adjusted depending on conditions of the impregnation of the work with phenol resin prior to the carbonization to provide a plurality of acoustic diaphragms having different properties.

As a result, the acoustic diaphragm characteristic can have a change (i.e., the acoustic diaphragm can have an increased design freedom). When this diaphragm is used as a speaker, the diaphragm can have a propagation speed set in a range of high values to have a better acoustic characteristic.

### Ninth Embodiment

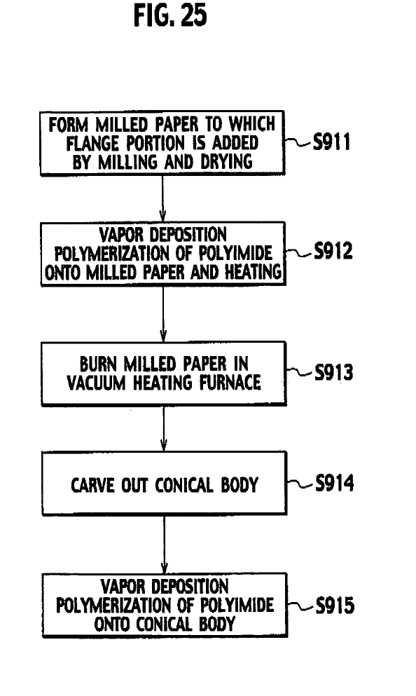

A ninth embodiment will be described with reference to FIG. 25 and FIGS. 26A to 23F. In the ninth embodiment, the second step S12 and the fifth step 815 of the first embodiment of the first embodiment shown in FIG. 1 are changed to the second step S912 and the fifth step S915 shown in FIG. 25, respectively. Thus, the first step S911, the third step S913, and the fourth step S914 shown in FIG. 25 are the same as the first step S11, the third step S13, and the fourth step S14 shown in FIG. 1 and thus will not be described further.

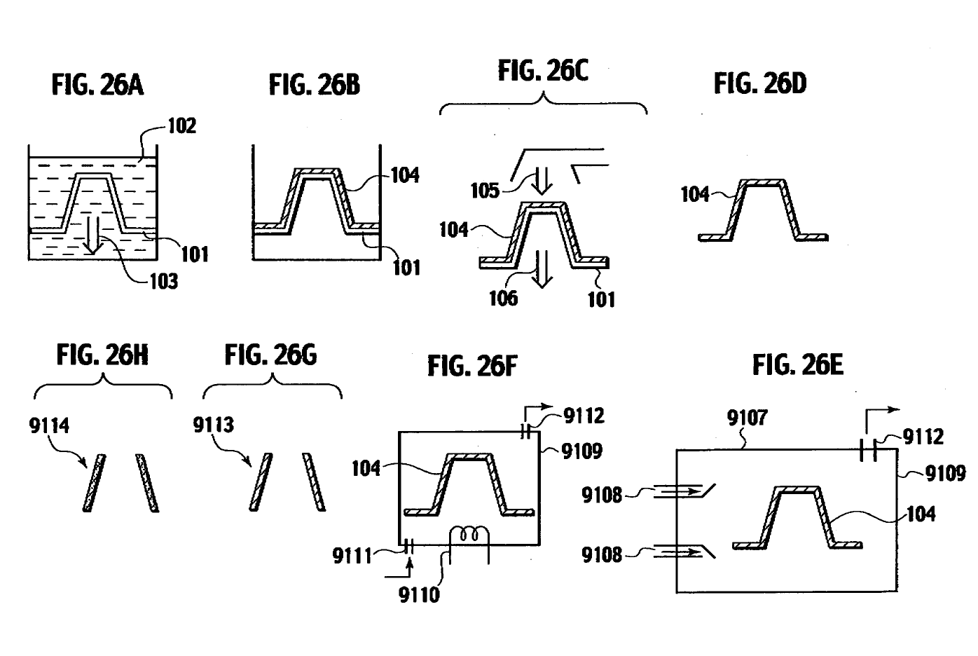

The ninth embodiment is different from the first embodiment shown in FIG. 2 in steps after FIG. 26E. Specifically, the ninth embodiment is different from the first embodiment in steps after the formation of the work 104. Thus, FIG. 26A to FIG. 26D are the same as FIG. 2A to FIG. 2D and thus will not be described further.

The second step S912 of FIG. 25 causes, as shown in FIG. 26E, the milled paper (workpiece) 104 detached from a mesh 101 to be placed in a vacuum bath 9107 having two gas introduction openings 9108. Exhaust through exhaust opening 9112 increases the vacuum degree in the vacuum bath 9107 to subsequently introduce pyromellitic dianhydride (PMDA) and oxydianiline (ODA) through the two gas introduction openings 9108 into the vacuum bath 9107, respectively. In the milled paper 104 and the interior previously heated to have substantially 200 degrees C., a reaction product of pyromellitic dianhydride and oxydianiline is generated. When the reaction product and the milled paper 104 are further heated at a temperature of substantially 300 degrees C. for substantially one hour, the reaction product changes into polyimide almost completely (vapor deposition polymerization).

Next, the third step S913 of FIG. 25 causes, as shown in FIG. 26F, the milled paper 104 obtained by subjecting polyimide to vapor deposition polymerization to be placed in the heating furnace 9109 to heat the milled paper 104 in atmosphere including substantially no oxygen (e.g., non-oxygenated atmosphere using nitrogen gas or the like) by the heater 9110 from the normal temperature to 800 degrees C. After the milled paper 104 is retained at 800 degrees C. for four hours, the milled paper 104 is cooled until the normal temperature is reached and is removed from the furnace. This step causes the carbonization of the organic substance included in the milled paper 104. Thus, the milled paper 104 turns into a porous carbide (porous carbide) including a great number of minute pores. It is noted that the reference numeral 9111 denotes an opening through which nitrogen gas or the like is introduced and the reference numeral 9112 denotes an opening through which nitrogen gas or the like is discharged.

Next, the fourth step S914 of FIG. 25 causes, as shown in FIG. 260, the conical body of this porous carbide 9113 to be cut off. It is noted that, if the paper-making process forms a small uneven part at the boundary between the cone-shaped part of the milled paper 104 and the other flat parts, the uneven part can be used as an indicator at which the cutting is carried out by a grindstone or a laser cutter for example and thus an accurate shape can be obtained.

Next, the fifth step S915 of FIG. 25 causes, as shown in FIG. 26H, the porous carbide conical body 9113 to be placed in the vacuum bath 9107 used in the second step (see FIG. 26E) to carry out exhaust through the exhaust opening 9112 to increase the vacuum degree of the vacuum bath 9107 to subsequently introduce pyromellitic dianhydride and oxydianiline through the two gas introduction openings 9108 into the vacuum bath 9107, respectively. At the entire surface and the interior of the porous carbide conical body 9113 previously heated to substantially 200 degrees C., a reaction product of pyromellitic dianhydride and oxydianiline is generated. After the generation of the reaction product of a predetermined amount, the porous carbide conical body 9113 is heated at substantially 300 degrees C. for substantially one hour to change the reaction product of pyromellitic dianhydride and oxydianiline into polyimide almost completely. At the surface (also including the end face) and the interior of the porous carbide 9113, the diaphragm 9114 having a polyimide resin film obtained by subjecting polyimide to a vapor deposition polymerization is generated.

The diaphragm 9114 obtained by subjecting polyimide to a vapor deposition polymerization has a sufficient sealing effect and can prevent an air leakage when the resultant acoustic diaphragm is used. Furthermore, polyimide can permeate the minute pores of the diaphragm 9114 to form a polyimide resin film on the interior and the surface of the diaphragm 9114, thus improving the mechanical strength of the resultant acoustic diaphragm. Furthermore, the diaphragm 9114 filled with polyimide having a high internal loss can enhance the internal loss to absorb the strain component caused when the diaphragm is used as a speaker, thereby improving the frequency characteristic. It is noted that, although various polyimides exist, polyimide herein assumes aromatic polyimide. When considering the application to vapor deposition polymerization, aromatic polyimide is considered as the best polyimide.

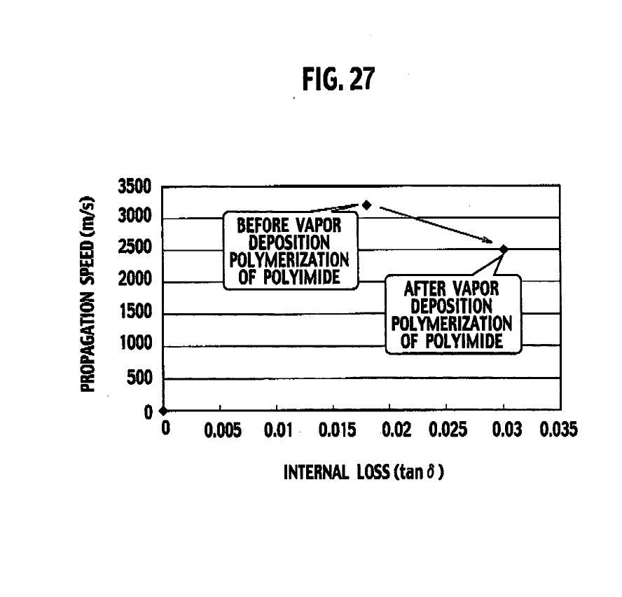

FIG. 27 shows a relation between the sound propagation speed and the internal loss tan δ before and after vapor deposition polymerization. The diaphragm 9114 obtained by subjecting hardened polyimide to a vapor deposition polymerization shows an increase of the weight of substantially 5 wt % when compared with that of the porous carbide conical body 9113 but this is generally within the range of the weight required for the acoustic diaphragm. The internal loss tan δ also increases from 0.018 before the vapor deposition of polyimide to 0.03 after the impregnation to show a substantially 50% improvement when compared with the porous carbide conical body 9113. As can be seen from FIG. 27, the propagation speed maintains high values.

It is noted that, “substantially anoxic atmosphere” used in the ninth embodiment preferably is nitrogen gas because nitrogen gas can be obtained with a low cost. In addition to nitrogen gas, argon or high vacuum atmosphere for example also may be used.

Although the ninth embodiment has described an example using the vapor deposition polymerization of polyimide, ureaformaldehyde resin also can be subjected to a vapor deposition polymerization. In this case, diphenylmethane diisocyanate and diaminophenylether are heated to have a gas form and the resultant gas is introduced in vacuum atmosphere. As a result, an ureaformaldehyde resin film can be formed on the surface while the above two substances reacting to each other on the work retained at substantially 180 degrees C. Although the resultant ureaformaldehyde resin film prepared by the vapor deposition polymerization ensures a a uniform film thickness, the resultant ureaformaldehyde resin film shows a heat resistance of 80 degrees C., which causes a practical problem in the resultant speaker.

### Tenth Embodiment

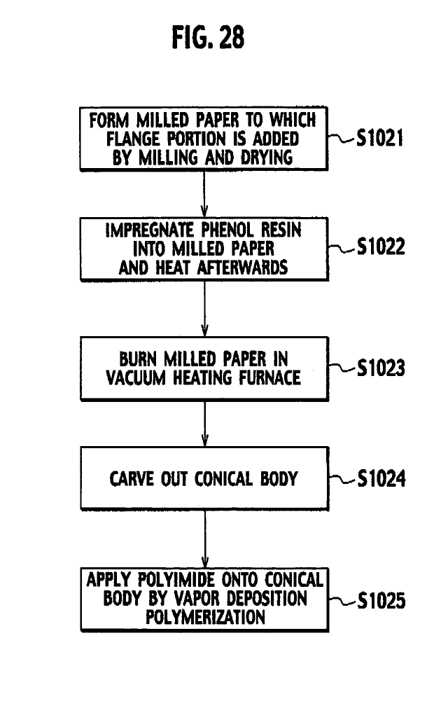

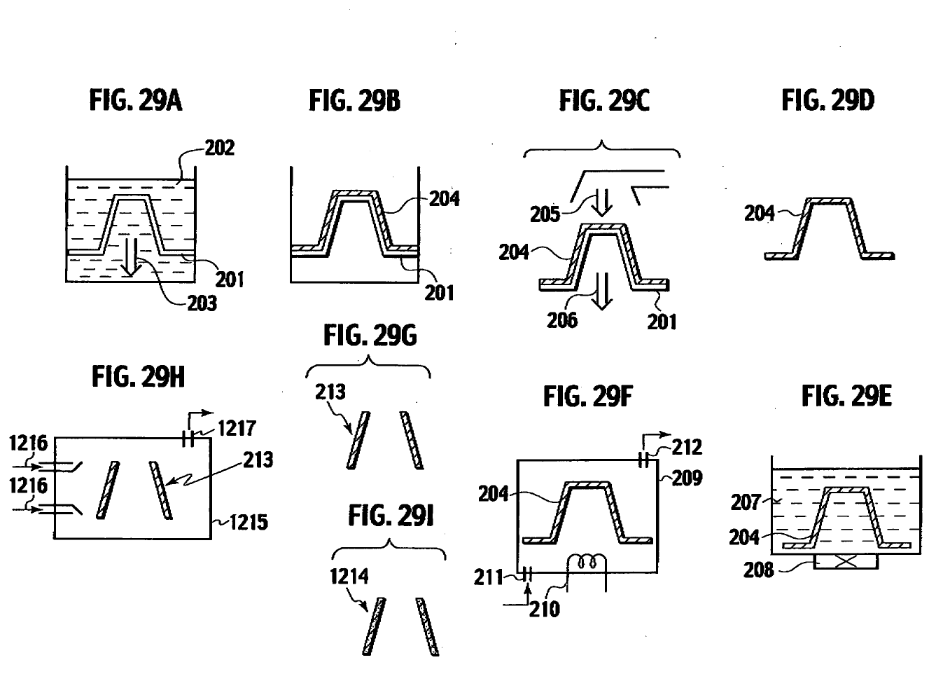

A tenth embodiment will be described with reference to FIG. 28 and FIG. 29A to 29H. The tenth embodiment is different from the second embodiment shown in FIG. 4 in the fifth step S1025 shown in FIG. 28. Thus, the first step S21 shown in FIG. 4 to the fourth step S24 are the same as the first step S1021 shown in FIG. 28 to the fourth step S1024 and thus will not be described further.

The tenth embodiment is also different from the second embodiment shown in FIG. 5 in the steps shown in FIGS. 29H and 29I. Specifically, the tenth embodiment is different from the second embodiment in that a step after the formation of the body cone part 213. Thus, FIG. 29A to FIG. 29G are the same as FIG. 5A to FIG. 5G and thus will not be described further.

The fifth step S1025 of FIG. 28 causes, as shown in FIG. 29H, the porous carbide conical body 213 to be placed in the vacuum bath 1215 to carry out exhaust through the exhaust opening 1217 to increase the vacuum degree of the vacuum bath 1215 to subsequently introduce pyromellitic dianhydride and oxydianiline through the two gas introduction openings 1216 into the vacuum bath 1215, respectively. At the surface and the interior of the porous carbide conical body 213 previously heated to substantially 200 degrees C., a reaction product of pyromellitic dianhydride and oxydianiline is generated. After a reaction product of a predetermined amount (e.g., an amount having a weight substantially 5 wt % larger than that of the porous carbide conical body 213) is generated, the porous carbide conical body 213 is heated at substantially 300 degrees C. for substantially one hour to change the reaction product of pyromellitic dianhydride and oxydianiline into polyimide almost completely. This results in the diaphragm 1214 having a polyimide resin film in which the surface (including the end face) and the interior of the porous carbide conical body 213 are subjected to vapor deposition polymerization with polyimide.

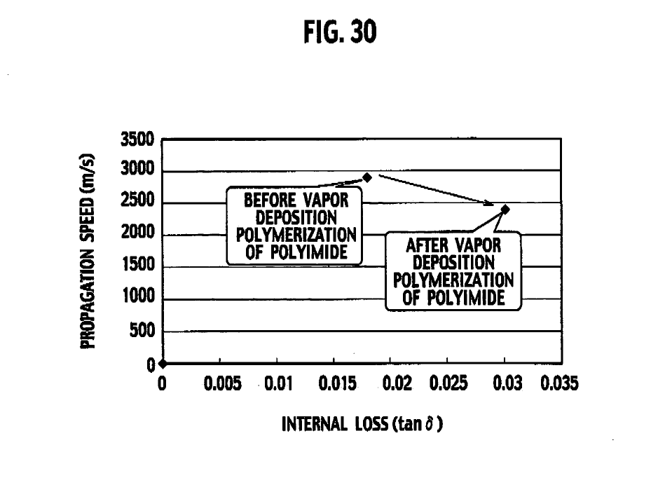

Although the diaphragm 1214 shows an increase in the weight of substantially 5 wt % from that of the porous carbide conical body 213, this is generally in the range of weights required for the acoustic diaphragm. The internal loss tan δ also increases from 0.018 the timing prior to the vapor deposition polymerization with polyimide to 0.03 after the impregnation, showing substantially sot improvement over the porous carbide conical body 213. FIG. 30 shows the relation between the propagation speed and the internal loss tan δ before and after the vapor deposition polymerization with polyimide.

When the diaphragm 1214 is compared with the one subjected to the vapor deposition polymerization with polyimide prior to the carbonization shown in the ninth embodiment, the diaphragm 1214 shows poor deposition thickness uniformity by the impregnation with phenol prior to the carbonization. Thus, the diaphragm 1214 has a poor sound propagation speed when compared with the diaphragm 9114 according to the ninth embodiment. This trend is also found when the vapor deposition polymerization with polyimide after the carbonization is the same.

However, the diaphragm 1214 according to the tenth embodiment is structured, as in the diaphragm 9114 according to the ninth embodiment, so that a flexible film is formed on the interior and the surface of the diaphragm 1214. Thus, the resultant acoustic diaphragm can be easily handled in the manufacture operations to prevent the speaker 13 from being broken during the assembly. Furthermore, the resultant acoustic diaphragm has an increased internal loss and thus the speaker has an improved frequency characteristic.

### Eleventh Embodiment

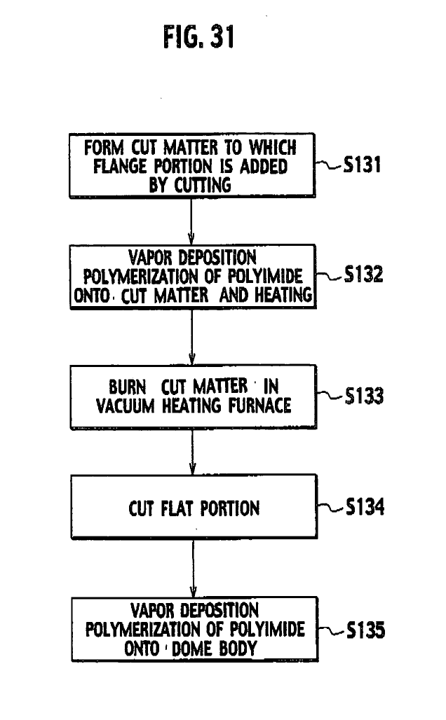

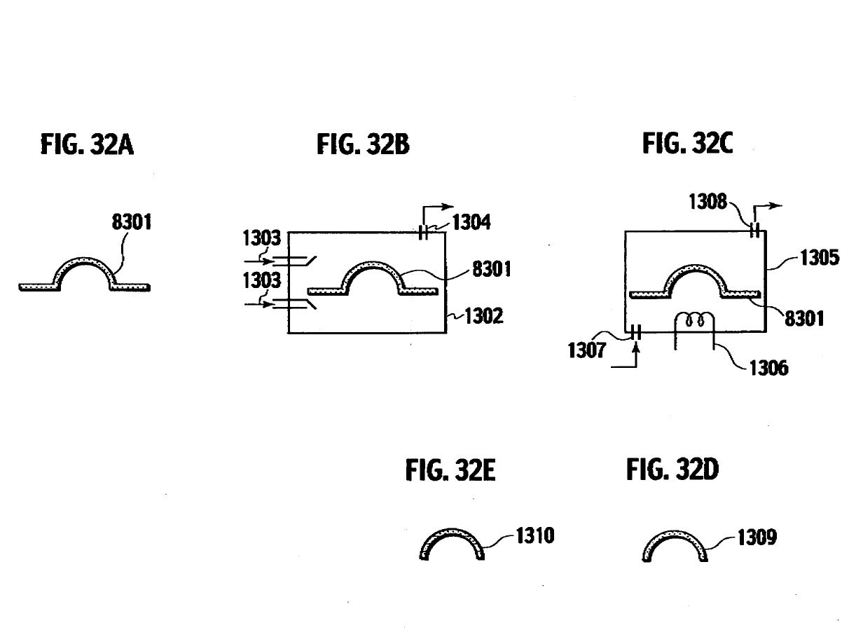

A method for manufacturing an acoustic diaphragm according to the eleventh embodiment will be described with reference to FIG. 31 and FIG. 32A to 32E. The eleventh embodiment is different in that and the second step S832 and the fifth step S835 of the eighth embodiment shown in FIG. 22 are changed to the second step S132 and the fifth step S135 shown in FIG. 31, respectively. Thus, the first step S131, the third step S133, and the fourth step S134 shown in FIG. 31 are the same as the first step S831, the third step S833, and the fourth step S834 shown in FIG. 22 and thus will not be described further.

The eleventh embodiment is different from the eighth embodiment shown in FIG. 23 in steps after FIG. 32B. Specifically, the eleventh embodiment is different from the eighth embodiment in steps after the formation of the cut matter 8301. Thus, FIG. 32A is the same as FIG. 23A and thus will not be described further.

It is noted that a hinoki cypress block can be cut so that the wood fibers are arranged in a substantially horizontal direction to the dome-like shape of FIG. 32A.

The second step S132 of FIG. 31 causes, as shown in FIG. 32B, this cut matter 8301 to be placed in the vacuum bath 1302 having two gas introduction openings 1303 to carry out exhaust through the exhaust opening 1304 to increase the vacuum degree of the vacuum bath 1302 to subsequently introduce pyromellitic dianhydride and oxydianiline through the two gas introduction openings 1303 into the vacuum bath 1302, respectively. On the cut matter 8301 and the interior previously heated to substantially 200 degrees C., the reaction product of pyromellitic dianhydride and oxydianiline is generated. The reaction product and the cut matter 8301 are further heated at substantially 300 degrees C. for one hour to change the reaction product of pyromellitic dianhydride and oxydianiline into polyimide almost completely.

The third step S133 shown in FIG. 31 causes, as shown in FIG. 32C, the cut matter 8301 obtained by subjecting polyimide to a vapor deposition polymerization to be placed in the vacuum heating furnace 1305 to heat (burn) the cut matter 8301 in substantially anoxic atmosphere (e.g., nitrogen gas atmosphere) by the heater 1306 from the normal temperature to 800 degrees C. After retaining the temperature at 800 degrees C. for four hours, the cut matter 8301 is cooled to the normal temperature and is removed from the furnace. This step causes the organic substance included in the cut matter 8301 to be carbonized. Thus, the cut matter 8301 obtained by subjecting polyimide to a vapor deposition polymerization turns into porous carbide including a great number of minute pores. It is noted that the reference numeral 1307 denotes an opening through which nitrogen gas or the like is introduced and the reference numeral 1308 is an outlet of nitrogen gas or the like.

Next, the fourth step S134 of FIG. 31 causes, as shown in FIG. 32D, the flat portion of the cut matter 8301 to be cut off to form a dome body 1309. It is noted that, if the first cutting step previously forms a small uneven portion at the boundary between the dome-like shape portion and the flat portion, this uneven portion can be used as an indicator at which the cutting is carried out the flat portion can be cut off accurately.

Next, the fifth step S135 of FIG. 31 places the porous carbide dome body 1309 in the vacuum bath 1302 used in the second step S132 to carry out exhaust through the exhaust opening 1304 to increase the vacuum degree of the vacuum bath 1302 to subsequently introduce pyromellitic dianhydride and oxydianiline through two gas introduction openings 1303 into the vacuum bath 1302, respectively. At the entire surface and the interior of the porous carbide dome body 1309 previously heated to substantially 200 degrees C., the reaction product of pyromellitic dianhydride and oxydianiline is generated. After the reaction product of a predetermined amount is formed, the porous carbide dome body 1309 is heated at substantially 300 degrees C. for substantially one hour to change the reaction product of pyromellitic dianhydride and oxydianiline into polyimide almost completely. As a result, the diaphragm 1310 is obtained in which the surface (including the end face) and the interior of the porous carbide dome body 1309 have thereon a polyimide resin film obtained by subjecting polyimide to a vapor deposition polymerization.

The diaphragm 1310 obtained by subjecting polyimide to a vapor deposition polymerization has a sufficient sealing effect and thus can prevent air leakage of the resultant acoustic diaphragm. Furthermore, polyimide permeates the pore of the porous carbide to form polyimide on the interior and the surface of the carbide. This can improve the mechanical strength of the acoustic diaphragm and polyimide having a high internal loss is filled to enhance the internal loss of the porous carbide to absorb a strain component caused when the diaphragm is used as a speaker, thereby improving the frequency characteristic.

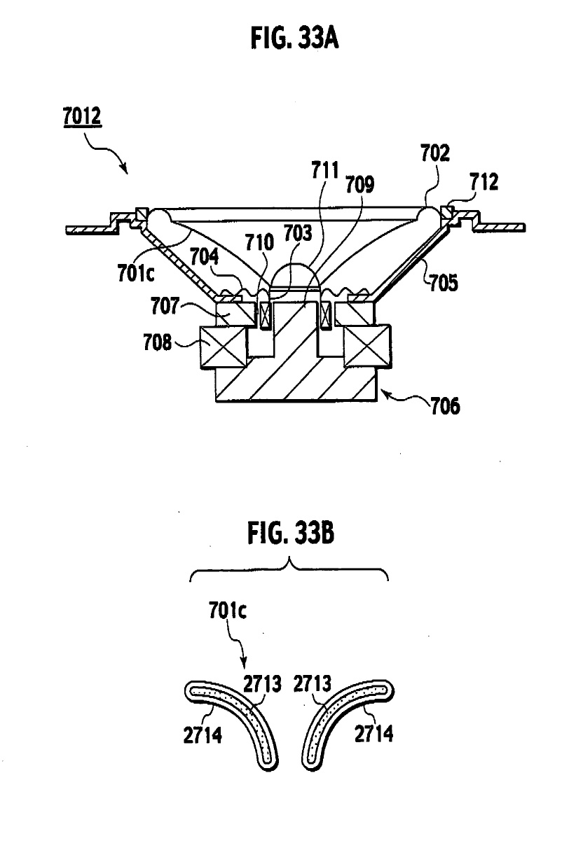

The speaker 7012 shown in FIG. 33A uses a cone-shaped acoustic diaphragm 701c that can be manufactured by any one manufacture method of those of the tenth embodiment or the eleventh embodiment. Those having the same structures in the speaker 7012 as those of the speaker 700 shown in FIG. 13 are denoted with the same reference numerals and thus will not be described further.

The acoustic diaphragm 701c is structured as shown in FIG. 33B so that the interior and the surface of the cone-shaped porous carbide 2713 have thereon a polyimide resin film for example. It is noted that the adhesion is further improved by rubbing the surface by a sandpaper for example for the purpose of improving the adhesion or by carrying out a surface processing by an appropriate primer.

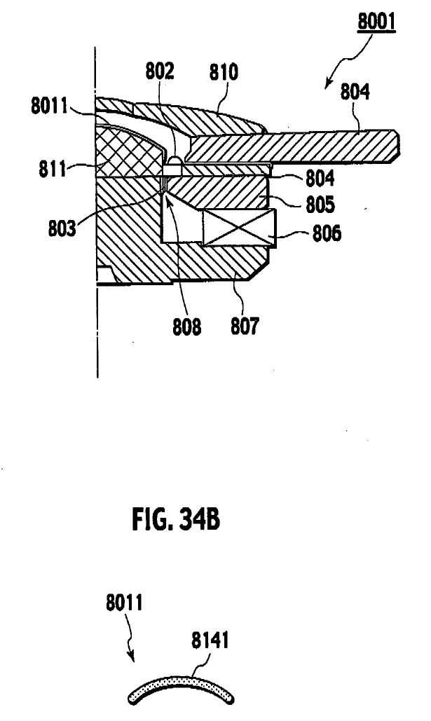

The speaker 8001 shown in FIG. 34A uses the dome-like-shaped diaphragm 8011 that can be prepared by the manufacture method of the eleventh embodiment. Those having the same structures in the speaker 8001 as those of the speaker 800 shown in FIG. 24 are denoted with the same reference numerals and thus will not be described further. This acoustic diaphragm 8011 may be, for example, a diaphragm 8141 as shown in FIG. 34B in which the interior or the surface has thereon a polyimide resin film.

In the ninth embodiment to the eleventh embodiment, polyimide means resin in which the molecule includes an imide group as a repeating unit. Polyimide in this invention can be manufactured by so-called solution coating, electrodeposition coating, or vapor deposition polymerization for example. The ninth embodiment to the eleventh embodiment preferably use the vapor deposition polymerization because the vapor deposition polymerization can allow resin to enter minute parts of the work, does not use solvent, and does not require an electric contact for example. The generation of a polyimide film by the vapor deposition polymerization is the same in both of a case where the work is an acoustic diaphragm-shaped natural material and a case where the work is an acoustic diaphragm having a high carbonization rate. First, raw material monomer (pyromellitic dianhydride and oxydianiline) heated and evaporated in vacuum atmosphere is caused to react to each other on a work previously heated in vacuum to prepare a polyamide acid film on the work to further increase the work temperature to generate polyimide to generate a polyimide film.

Polyimide has a long-time heat resistance (UL standard) of substantially 240 to 280 degrees C. Thus, when the entire acoustic diaphragm having a high carbonization rate is covered by polyimide, a sufficient heat resistance is obtained under an environment in which the speaker is used. A speaker having a high output also can use an acoustic diaphragm covered by polyimide.

In the ninth embodiment to the eleventh embodiment, a polyimide film or a phenol resin film is formed on the interior and the surface of the shape-formed work to subsequently burn the work under substantially non-oxygenated atmosphere to carbonize organic substance. Thereafter, the burned work has thereon a resin film including polyimide. This can realize the prevention of air leakage, an improved strength, an enhanced internal loss, and an increased propagation speed.

In the ninth embodiment to the eleventh embodiment, “phenol resin” is preferably the one obtained by dissolving phenol resin by solvent of alcohols (e.g., methanol, ethanol, acetic ether) having a low boiling point (80 degrees C. or less) because this improves the productivity and the yield rate.

It is noted that polyimide can be coated on any part of the work obtained by burning natural material in substantially non-oxygenated atmosphere to carbonize the natural material so long as the coated part can effectively prevent air leakage and provides homogeneous physical characteristics such as an internal loss. However, since an end face of the work includes openings at ends of a great number of minute cells (e.g., wood and natural fibers) and has an identical shape even after the carbonization, it is necessary and effective to coat this part in order to prevent air leakage and to provide additional strength.

When a sealing effect by phenol resin is compared with a sealing effect by polyimide, polyimide provides improved deposition thickness uniformity when compared to that by phenol resin. Thus, polyimide attached in a small amount can provide a sealing effect. Thus, the use of polyimide can provide a diaphragm having a lighter weight and less air leakage than in the case of phenol. Furthermore, polyimide has a property having a higher internal loss. Thus, polyimide attached in a small amount can provide a high internal loss to provide a diaphragm having a lighter weight and a higher internal loss than in the case of phenol resin. This sealing using polyimide by the vapor deposition polymerization does not use solvent and thus causes a small adverse impact on an environment and thus is a process having a good workability. Thus, a smaller adverse impact is caused on an environment than in the case of solvent-type phenol resin to provide a low-cost diaphragm. Since polyimide has a high heat resistance, polyimide can endure a high temperature when compared with a case where phenol resin is used and can be adopted, with a higher probability, to a speaker used under environment having a higher temperature than in the case of phenol resin.

When an effect by the impregnation of a natural material diaphragm with phenol resin is compared with that by the impregnation of a natural material diaphragm with polyimide, polyimide has an improved deposition thickness uniformity when compared to that of phenol resin and thus allows polyimide to enter the most part of the interior of the natural material diaphragm. Thus, when this is carbonized, an acoustic diaphragm having a higher density and a higher carbonization rate is obtained than in the case where phenol resin is used and an amount of attached polyimide used in the subsequent sealing process can be reduced, thus providing a property different from that obtained when phenol resin is used. As a result, the diaphragm property can have a change (i.e., can have an increased design freedom). When the diaphragm is used as a speaker, the diaphragm can have a propagation speed set at a high value, thus providing a better acoustic characteristic. It is noted that the addition of phenol resin or polyimide to the natural material diaphragm also may be carried out not only by impregnation but also by atomizing, spraying, coating, or injection.

Embodiments of the present invention are described above with detailed examples, however, it should be understood that many modifications and adaptations of the invention will become apparent to those skilled in the art and it is intended to encompass such obvious modifications and changes in the scope of the claims appended hereto.

What is claimed is:

1. A method of producing an acoustic diaphragm comprising:
forming a workpiece having a shape of the acoustic diaphragm by using a natural material which can be carbonized by burning;
forming a first film including phenol resin on a surface and an interior of the workpiece;
heating the workpiece to bring the phenol resin into a high polymer state;
burning the workpiece in a substantially anoxic atmosphere to carbonize the workpiece and the first film; and
forming a second film including gelatin on at least one of a surface and an interior of carbonized workpiece.

2. The method of claim 1, further comprising:
forming a third film including phenol resin on the workpiece before forming the second film.

3. The method of claim 1, further comprising:
forming a third film including phenol resin on the carbonized workpiece after forming the second film.

4. The method of claim 1, wherein the first film is formed by impregnating a phenol solution into the workpiece, and the second film is formed by applying or impregnating a coating material including gelatin into the workpiece.

5. The method of claim 1, wherein the second film is formed by applying or impregnating a gelatin solution including substantially 1-20 wt % of gelatin.

6. The method of claim 5, wherein the gelatin solution further includes a surfactant of sodium lauryl sulfate, an ethanol, or an aldehyde-base cross-linking agent.

7. An acoustic diaphragm comprising:
a porous carbide body having a shape of a diaphragm including a carbide of a natural material and a carbide of phenol resin; and
a hardened film of gelatin formed on at least one of a surface and an interior of the porous carbide body.

8. The acoustic diaphragm of claim 7, wherein the hardened film is formed on an end face of the porous carbide body.

9. A speaker that uses the acoustic diaphragm according to claim 7.

10. A method of producing an acoustic diaphragm comprising:
forming a workpiece having a shape of the acoustic diaphragm by using a natural material which can be carbonized by burning;
forming a first polyimide resin film on a surface and an interior of the workpiece;
burning the workpiece in a substantially anoxic atmosphere to carbonize the workpiece and the first polyimide resin film; and
forming a second polyimide resin film on at least one of a surface and an interior of carbonized workpiece.

11. A method of producing an acoustic diaphragm comprising:
forming a workpiece having a shape of the acoustic diaphragm by using a natural material which can be carbonized by burning;
forming a phenol resin film on a surface and an interior of the workpiece;
burning the workpiece in a substantially anoxic atmosphere to carbonize the workpiece and the phenol resin film; and
forming a polyimide resin film on at least one of a surface and an interior of carbonized workpiece.

12. The method of claim 10, wherein each of the first and second polyimide resin film is formed by a vapor deposition polymerization using pyromellitic dianhydride gas and oxydianiline gas.

13. The method of claim 10, wherein each of the first and second polyimide resin film is formed by:
preheating the workpiece in a vacuum bath at a preheating temperature;
introducing raw material monomers of the polyimide resin film into the vacuum bath in which the preheated workpiece is installed; and
heating the preheated workpiece at a heating temperature higher than the preheating temperature.

14. The method of claim 11, wherein the polyimide resin film is formed by a vapor deposition polymerization using pyromellitic dianhydride gas and oxydianiline gas.

15. The method of claim 11, wherein the polyimide resin film is formed by:
preheating the workpiece in a vacuum bath at about 200° C.;
introducing raw material monomers of the polyimide resin film into the vacuum bath at about 200° C.; and
heating the preheated workpiece at about 300° C.

16. An acoustic diaphragm comprising:
a porous carbide body having a shape of a diaphragm including a carbide of a natural material and a carbide of polyimide resin; and
a polyimide resin film formed on at least one of a surface and an interior of the porous carbide body.

17. The acoustic diaphragm of claim 16, wherein the polyimide resin film is formed on an end face of the workpiece.

18. A speaker that uses the acoustic diaphragm according to claim 16.
